(19) United States
(12) Patent Application Publication
(10) Pub. No.: US 2020/0216752 A1
(43) Pub. Date: Jul. 9, 2020

(54) HYDROXYL-FUNCTIONAL UNSATURATED POLYAMINE SILICONE LIGAND SUITABLE FOR QUANTUM DOT COMPOSITIONS AND ARTICLES

(71) Applicant: 3M INNOVATIVE PROPERTIES COMPANY, St. Paul, MN (US)

(72) Inventors: Zai-Ming QIU, Woodbury, MN (US); Joseph M. PIEPER, Atlanta, GA (US); Eric W. NELSON, Stillwater, MN (US)

(21) Appl. No.: 16/647,796

(22) PCT Filed: Sep. 18, 2018
(86) PCT No.: PCT/IB2018/057179

§ 371 Date: Mar. 16, 2020

Related U.S. Application Data
(60) Provisional application No. 62/559,976, filed on Sep. 18, 2017.

(51) Int. Cl. C09K 11/02; C08G 77/26; C08G 77/06; C08L 23/02; C08L 81/02

(52) U.S. Cl. CPC C09K 11/025; C08G 77/26; B82Y 20/00; C08L 23/02; C08L 81/02; C08G 77/06

(57) ABSTRACT

A quantum dot article comprises (a) a first barrier layer, (b) a second barrier layer, and (c) a quantum dot layer between the first barrier layer and the second barrier layer, the quantum dot layer comprises light-emitting nanoparticles dispersed in a cured matrix; wherein the quantum dot layer further comprises a hydroxyl-functional unsaturated polyamine silicone ligand that is the reaction product of a polyamine silicone ligand and an unsaturated monofunctional epoxy compound.

### BACKGROUND

Quantum Dot Enhancement Films (QDEF) are used in LCD displays. Red and green quantum dots in the film down-convert light from the blue LED source to give white light. This has the advantage of improving the color gamut over the typical LCD display and decreasing the energy consumption.

Quantum dots, or light-emitting nanoparticles are stabilized with one or more organic ligands to improve quantum efficiency and stability.

Quantum dot film articles include quantum dots dispersed in an organic polymeric matrix that is laminated between two barrier (e.g. film) layers that protect the quantum dots from degradation. A preferred organic polymeric matrix is a thiol-ene matrix, such as described in WO2016/081219. Nevertheless, further improving the length of time a quantum dot film can suitably down-convert light is beneficial, particularly under high blue flux conditions.

### SUMMARY

Therefore, industry would find advantages in quantum dot compositions and articles that can suitably down-convert (e.g. blue) light for longer periods of time.

In one embodiment, a quantum dot article is described comprising a first barrier layer, a second barrier layer, and a quantum dot layer between the first and second barrier layer. The quantum dot layer comprises light-emitting nanoparticles dispersed in a cured matrix. The quantum dot layer further comprises a hydroxyl-functional polyamine silicone ligand that is the reaction product of a polyamine silicone ligand and an unsaturated monofunctional epoxy compound.

In another embodiment, a hydroxyl-functional polyamine silicone is described that is the reaction product of a polyamine silicone and an unsaturated monofunctional epoxy compound.

Preferably, at least 50 mol % of primary amine groups (—NH₂) of the polyamine silicone are reacted with the unsaturated monofunctional epoxy compound, thereby reducing the concentration of primary amine groups.

In some embodiments, the hydroxyl-functional unsaturated polyamine silicone ligand may be represented by the following structure:

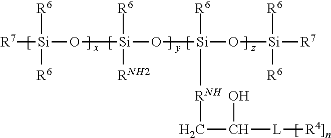

wherein
each R⁶ is independently a hydrocarbyl group including alkyl, aryl, alkarylene, and aralkylene,
R^{NH2} is an amine-substituted (hetero)hydrocarbyl group;
x is at least 1, 2 or 3 and ranges up to 2000;
y is 0 to 10;
z is 0 to 10;
n is at least 1;
L is a covalent bond or polyvalent linking group;
R⁴ is independently an unsaturated group, such as an alkenyl or alkynyl group; and
R⁷ is alkyl, aryl, R^{NH2}, or —NHCH₂CH(OH)L(R⁴)n; with the proviso that when z is 0, at least one R⁷ —NHCH₂CH(OH)L(R⁴)n, and when y is zero at least one R⁷ is R^{NH2}.

In some embodiments, the molar ratio of —NHCH₂CH(OH)L(R⁴)n groups to R^{NH2} ranges from 1:1 to 9:1.

In another embodiment, a quantum dot composition is described comprising light-emitting quantum dots and the hydroxy-functional unsaturated polyamine silicone ligand described herein.

In another embodiment, a curable quantum dot composition is described comprising light-emitting quantum dots and the hydroxy-functional unsaturated polyamine silicone ligand described herein dispersed in a curable resin composition. In some embodiments, the curable resin composition further comprises at least one polythiol and at least one polyene.

### BRIEF DESCRIPTION OF THE DRAWINGS

FIG. 1 is a schematic side elevation view of an edge region of an illustrative film article including quantum dots.

FIG. 2 is a flow diagram of an illustrative method of forming a quantum dot film.

FIG. 3 is a schematic illustration of an embodiment of a display including a quantum dot article.

FIGS. 4-7 are plots of normalized converted radiance versus time of exposure to high intensity blue light.

### DETAILED DESCRIPTION

The quantum dot composition described herein comprises light-emitting nanoparticles. The nanoparticle typically includes a core and a shell at least partially surrounding the core. Such core-shell nanoparticles can have two distinct layers, a semiconductor or metallic core and a shell surrounding or insulating the core of a semiconductor material. The core often contains a first semiconductor material and the shell often contains a second semiconductor material that is different than the first semiconductor material. For example, a first Group 12-16 (e.g., CdSe) semiconductor material can be present in the core and a second Group 12-16 (e.g., ZnS) semiconductor material can be present in the shell.

In some embodiments, the core includes a metal phosphide (e.g., indium phosphide (InP), gallium phosphide (GaP), aluminum phosphide (AlP)), a metal selenide (e.g., cadmium selenide (CdSe), zinc selenide (ZnSe), magnesium selenide (MgSe)), or a metal telluride (e.g., cadmium telluride (CdTe), zinc telluride (ZnTe)). In some preferred embodiments, the core includes a metal selenide (e.g., cadmium selenide).

The shell can be a single layer or multilayered. In some embodiments, the shell is a multilayered shell. The shell can include any of the core materials described herein. In certain embodiments, the shell material can be a semiconductor material having a higher bandgap energy than the semiconductor core. In other embodiments, suitable shell materials can have good conduction and valence band offset with respect to the semiconductor core, and in some embodiments, the conduction band can be higher and the valence band can be lower than those of the core. For example, in some embodiments, semiconductor cores that emit energy in the visible region such as, for example, CdS, CdSe, CdTe, ZnSe, ZnTe, GaP, InP, or GaAs, or near IR region such as, for example, InP, InAs, InSb, PbS, or PbSe may be coated with a shell material having a bandgap energy in the ultraviolet regions such as, for example, ZnS, GaN, and magnesium chalcogenides such as MgS, MgSe, and MgTe. In other embodiments, semiconductor cores that emit in the near IR region can be coated with a material having a bandgap energy in the visible region such as CdS or ZnSe.

Formation of the core-shell nanoparticles may be carried out by a variety of methods. Suitable core and shell precursors useful for preparing semiconductor cores are known in the art and can include Group 2 elements, Group 12 elements, Group 13 elements, Group 14 elements, Group 15 elements, Group 16 elements, and salt forms thereof. For example, a first precursor may include metal salt (M+X−) including a metal atom (M+) such as, for example, Zn, Cd, Hg, Mg, Ca, Sr, Ba, Ga, In, Al, Pb, Ge, Si, or in salts and a counter ion (X−), or organometallic species such as, for example, dialkyl metal complexes. The preparation of a coated semiconductor nanocrystal core and core/shell nanocrystals can be found in, for example, Dabbousi et al. (1997) J. Phys. Chem. B 101:9463, Hines et al. (1996) J. Phys. Chem. 100: 468-471, and Peng et al. (1997) J. Amer. Chem. Soc. 119:7019-7029, as well as in U.S. Pat. No. 8,283,412 (Liu et al.) and International Publication No. WO 2010/039897 (Tulsky et al.).

In some embodiments, the shell includes a metal sulfide (e.g., zinc sulfide or cadmium sulfide). In some embodiments, the shell includes a zinc-containing compound (e.g., zinc sulfide or zinc selenide). In some embodiments, a multilayered shell includes an inner shell overcoating the core, wherein the inner shell includes zinc selenide and zinc sulfide. In some embodiments, a multilayered shell includes an outer shell overcoating the inner shell, wherein the outer shell includes zinc sulfide.

In some embodiments, the core of the shell-core nanoparticle contains a metal phosphide such as indium phosphide, gallium phosphide, or aluminum phosphide. The shell contains zinc sulfide, zinc selenide, or a combination thereof. In some more particular embodiments, the core contains indium phosphide and the shell is multilayered with the inner shell containing both zinc selenide and zinc sulfide and the outer shell containing zinc sulfide.

The thickness of the shell(s) may vary among embodiments and can affect fluorescence wavelength, quantum yield, fluorescence stability, and other photostability characteristics of the nanocrystal. The skilled artisan can select the appropriate thickness to achieve desired properties and may modify the method of making the core-shell nanoparticles to achieve the appropriate thickness of the shell(s).

The nanoparticles typically have an average particle diameter of at least 0.1 nanometer (nm), or at least 0.5 nm, or at least 1 nm. The nanoparticles have an average particle diameter of up to 1000 nm, or up to 500 nm, or up to 200 nm, or up to 100 nm, or up to 50 nm, or up to 20 nm, or up to 10 nm.

The diameter of the (e.g. core-shell) nanoparticles controls its fluorescence wavelength. The diameter of the quantum dot is often designed for a specific fluorescence wavelength. For example, cadmium selenide quantum dots having an average particle diameter of about 2 to 3 nanometers tend to fluoresce in the blue or green regions of the visible spectrum while cadmium selenide quantum dots having an average particle diameter of about 8 to 10 nanometers tend to fluoresce in the red region of the visible spectrum.

The light-emitting nanoparticles are often stabilized with one or more ligands. Typically, the light-emitting nanoparticles are surface modified with one or more oligomeric or polymeric ligands. The nanoparticles together with the ligands may be characterized as a composite. Typical ligands may be of the following Formula I:

R¹⁵—R¹²(X)ₙ

wherein

R¹⁵ is (hetero)hydrocarbyl group, typically having 1 to 30 carbon atoms;

R¹² is a (e.g. divalent) hydrocarbyl group including alkylene, arylene, alkarylene and aralkylene, typically having 1 to 30 carbon atoms;

n is at least one;

X is a ligand group, including —SH, —CO₂H, —SO₃H, —P(O)(OH)₂, —OP(O)(OH), —OH and —NH₂.

In some embodiments, the combination of R¹⁵ and R¹² comprises at least 4 or 6 carbon atoms.

The nanoparticles comprise polyamine silicone ligands for better quantum efficiency and stability. The polyamine silicone ligand typically has the following Formula II:

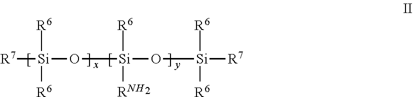

wherein
each R⁶ a hydrocarbyl group including alkyl, aryl, alkarylene and aralkylene, typically having 1 to 30 carbon atoms;
R^{NH2} is an amine-terminated (hetero)hydrocarbyl group or an amine-terminated;
x is at least 1, 2 or 3 and ranges up to 2000;
y is 0, 1 or greater than 1;
x+y is at least one;
R⁷ is alkyl, aryl or R^{NH2}.
wherein amine-functional silicone has at least two R^{NH2} groups.

In some embodiments, R⁶ is a C¹, C², C³, or C⁴ alkyl group. In other embodiments, R⁶ comprises an aromatic group (e.g. phenyl).

In some embodiments, x is no greater than 1500, 1000, 500, 400, 300, 200, or 100. Mixture of amine-functional ligands of Formulas I and polyamine silicone ligands of Formula II may be used.

Suitable polyamine silicone ligands are described in Lubkowsha et al., Aminoalkyl Functionalized Siloxanes, Polimery, 2014 59, pp 763-768; as well as US2013/0345458 and U.S. Pat. No. 8,283,412, both of which are incorporated herein by reference. Some representative polyamine silicone ligands include, but are not limited to,

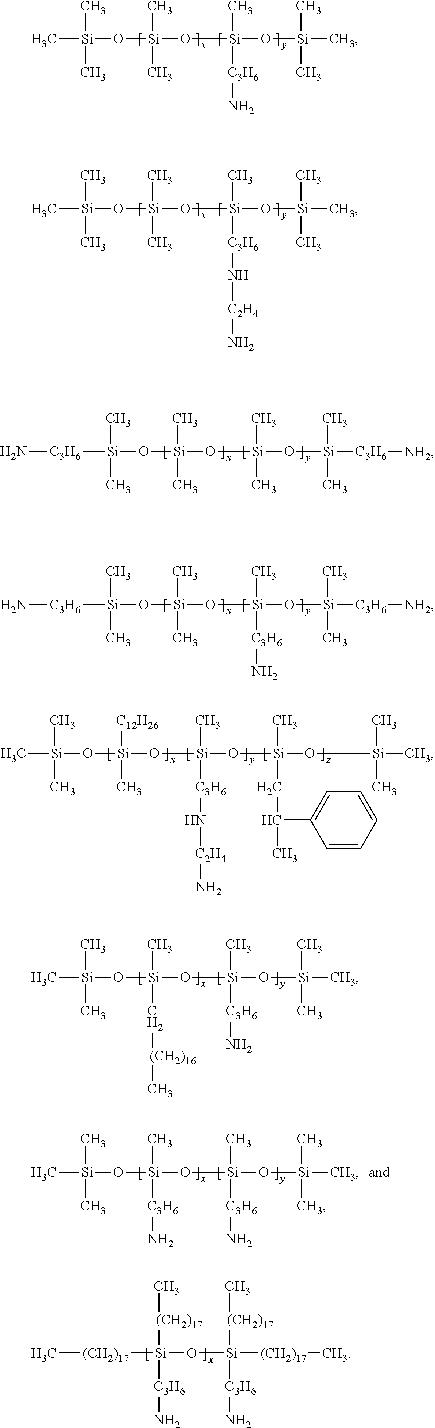

Polyamine silicone ligands wherein R^{NH2} is an amine-substituted (hetero)hydrocarbyl group can be prepared as described in U.S. Application Ser. No. 62/396,401 filed Sep. 19, 2016; incorporated herein by reference.

Polyamine silicone ligands are commercially available from a variety of suppliers such as Gelest as the trade designations AMS-132, AMS-152 AMS-162, AMS-233, and AMS-242. Genesee Polymers Corporation as the trade designations GP-4, GP-6, GP-145, GP-316, GP-344, GP-345, GP-397, GP-468, GP-581, GP-654, GP-657, GP-RA-157, GP-871, GP-846, GP-965, GP-966 and GP-988.

Polyamine silicone ligands are commercially available from Dow Corning as Xiameter™, including Xiamter OFX-0479, OFX-8040, OFX-8166, OFX-8220, OFX-8417, OFX-8630, OFX-8803, and OFX-8822. Other polyamine silicone ligands are available from Siletech.com under the tradenames Silamine™, and from Momentive.com under the tradenames ASF3830, SF4901, Magnasoft, Magnasoft PlusTSF4709, Baysilone OF-TP3309, RPS-116, XF40-C3029 and TSF4707.

In some embodiments, the polyamine silicone ligand may be utilized as a surface modifying agent when synthesizing or functionalizing the (e.g. core-shell) nanoparticles. For example, quantum dots further comprising a polyamine silicone ligand are commercially available from Nanosys Inc., Milpitas, Calif. In some embodiments, the (e.g. commercially available) quantum dots comprise at least 75, 80, 85 or 90 wt.-% of polyamine silicone ligand and at least 10, 15, 20, or 25 wt. % nanoparticles.

Typically, excess polyamine silicone ligands are present when the nanoparticles are surface modified. Polyamine silicon ligands can also be added to the quantum dot composition. This results in the quantum dot composition comprising excess polyamine silicone ligand (e.g. of Formula II) relative to the amount needed for stabilization of the light-emitting nanoparticles. The excess polyamine silicone ligand can be beneficial to provide a low viscosity liquid that can be easily dispersed in the polymerizable (e.g. polythiol-polyene) resin. However, it has been observed that the presence of excess polyamine silicone ligands results in unbonded, free primary amine groups being present that can react and degrade the surrounding cured matrix (i.e. cured polymerizable resin composition) after exposure to high intensity blue light. Without intending to be bound by theory, this is particularly problematic with the cured matric comprises amine-reactive groups, such as ester groups. Therefore, reducing the concentration of free primary amine groups can improve the stability and in turn extend the lifetime. This is particularly beneficial for some applications, such as television displays. The free amine groups of the polyamine silicone ligands can be reduced or minimized by addition of an amine-reactive component (e.g. monomer), as described in U.S. Application Ser. No. 62/543,563.

It has also been found that the addition of hydroxyl-functional unsaturated polyamine silicone ligand can improve the stability and in turn extend the lifetime of quantum dot compositions and articles. The presence of the ethylenic unsaturation is amenable to copolymerization with the polymerizable resin of the quantum dot layer.

The hydroxyl-functional unsaturated polyamine silicone ligand is the reaction product of a polyamine silicone ligand (e.g. of Formula II), as previously described, and an unsaturated monofunctional epoxy compound.

The reaction of a primary amine with an epoxy group is known. One representative reaction scheme of a polyamine silicone ligand with a monofunctional epoxy compound is depicted as follows:

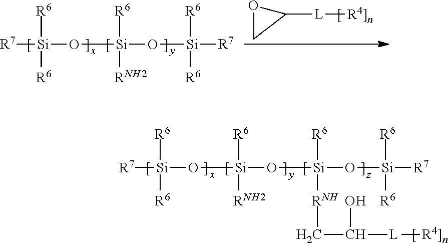

As evident by the reaction scheme, a portion of the primary amine groups are reacted with the monofunctional epoxy compound, thereby converting the primary amine to a secondary amine, —NHCH₂CH(OH)L(R⁴)n. Therefore, such reaction reduces the excess free primary amine groups of the polyamine silicone ligand.

There are a variety of ways in which this reaction can be utilized to reduce the concentration of primary amine of the quantum dot composition and resulting articles. In one embodiment, as demonstrated in the forthcoming examples, a hydroxyl-functional unsaturated polyamine silicone ligand can be synthesized and combined with the light-emitting nanoparticles and polymerizable resin composition of the curable quantum dot compositions. In another embodiment, the synthesized hydroxyl-functional unsaturated polyamine silicone ligand can be utilized to stabilize the light-emitting nanoparticles or in other words utilized as a surface modifying agent when synthesizing or functionalizing the (e.g. core-shell) nanoparticles. In this embodiment, the hydroxyl-functional unsaturated polyamine silicone ligand may be utilized in combination with the previously described polyamine silicone ligands. In yet another embodiment, the polyamine silicone ligand stabilized quantum dots composition can be reacted with the unsaturated monofunctional epoxy compound.

When the hydroxyl-functional unsaturated polyamine silicone ligand is post-added to stabilized light-emitting nanoparticles, the light-emitting nanoparticles comprise a mixture of polyamine silicone ligands. In some embodiments, the mixtures comprise polyamine silicone ligand(s) (e.g. of Formula II) and/or ligands according to Formula I and/or hydroxyl-functional polyamine silicone ligands (lacking unsaturated groups) as described in cofiled 78688US002; incorporated herein by reference.

When the hydroxyl-functional unsaturated polyamine silicone ligand is utilized as a surface treatment to stabilize the light-emitting nanoparticles, the light-emitting nanoparticles may comprise solely the hydroxyl-functional unsaturated polyamine silicone ligand described herein. Alternatively, the light-emitting nanoparticles may comprise a mixture of silicone ligands that comprises the hydroxyl-functional and unsaturated polyamine silicone ligand described herein. The mixture of silicone ligands may further comprise polyamine silicone ligand(s) (e.g. of Formula II) and/or ligands according to Formula I and/or hydroxyl-functional polyamine silicone ligands (lacking unsaturated groups) as described in cofiled 78688US002; incorporated herein by reference.

Any of the previously described polyamine silicone ligands (e.g. of Formula II) can be utilized as a starting material in the preparation of the hydroxyl-functional unsaturated polyamine silicone ligand. One representative polyamine silicone ligand is depicted as follows:

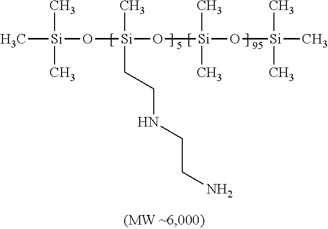

Various monofunctional epoxy compounds can be utilized to react with the primary amine group of the polyamine silicone ligand. Unlike epoxy crosslinking compounds that have two or more epoxy groups, “monofunctional” means that the epoxy compound has one epoxy ring or in other words one reactive cite.

The monofunctional unsaturated epoxy compound typically has the formula

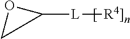

wherein L is a covalent bond or a polyvalent organic linking group, R⁴ is independently an unsaturated group, and n is at least 1.

The organic linking group typically comprises no greater than 30, 25, 20, 15, or 10 carbon atoms. In some embodiment, the organic linking group has no greater than 9, 8, 7, 6, or 5 or 4 carbon atoms. The organic group may be linear, branched, and may comprise cyclic moieties. In some embodiments, L is alkylene, arylene, alkarylene and aralkylene. The organic linking group may further comprise heteroatoms such as N, S, or O. Thus, the linking group may be characterized as an ether, polyether, thiol, polythiol, ester, or (e.g. tertiary) amine

R⁴ is typically a terminal alkenyl group comprising a carbon-carbon double bond or a terminal alkynyl group comprising a carbon-carbon triple bond. In this embodiment, R⁴ is not a (meth)acrylate group. Thus the carbon atom of the unsaturated carbon-carbon double bond is not bonded to an oxygen atom or in other words is not part of an ester group.

Various unsaturated epoxy compounds can be utilized.

In some embodiments, L is an alkylene group and le is a terminal carbon-carbon double bond. The -L(R⁴)n group may be characterized as an alkene. Some illustrative compounds include for example 1,2-epoxy-5-hexene; 1,2-epoxy-7-octene; and 1,2-epoxy-9-decene. Other unsaturated epoxy compounds wherein L comprises a branched or cyclic alkylene group are depicted as follows:

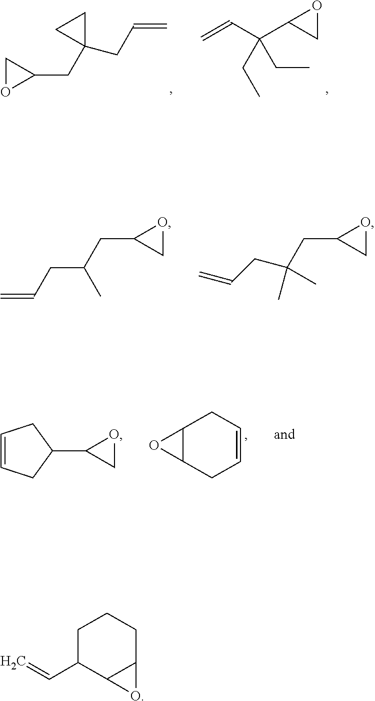

In some embodiments, L may be characterized as an alkylene further comprising contiguous oxygen and/or sulfur atoms. In this embodiment, L may be an ether, polyether, thioether, polythioether, ester, and the like. Some illustrative compounds include for example

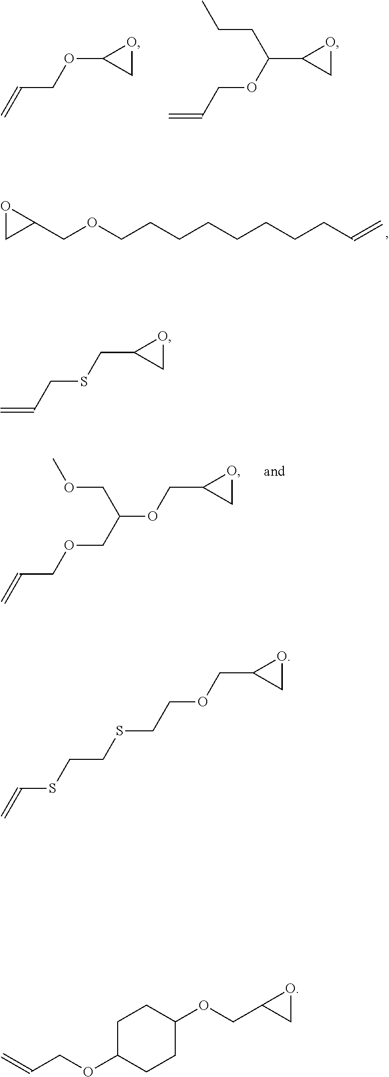

In other embodiments, L may be characterized as an arylene, alkarylene, or aryalkylene further comprising contiguous oxygen and/or sulfur atoms. Some illustrative compounds include for example.

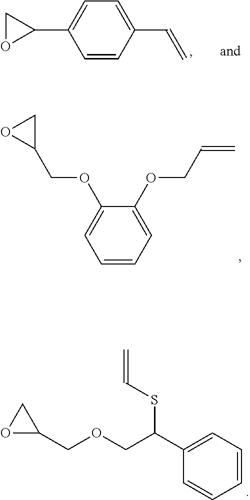 [SMILES: C=Cc1ccc(C2CO2)cc1 ; C=CCOc1ccccc1OCC1CO1 ; C=CSC(COCC1CO1)c1ccccc1]

In some embodiments, the unsaturated monofunctional epoxy compound has the general structure depicted above wherein n is two. Some illustrative compounds include for example 1,3diallyl-5-oxiranylmethyl-[1,3,5]triazinane-2,4,6-trione, available from MOLBASE Bioechnology Co, Ltd. Shanghai, China; [1-(1-methylethyl)-1-(2-propenyl)-3-butenyl]-oxirane, and 2-(3-methylidenepent-4-en-1-yl)oxirane and [1-(allyl)-3-butenyl]-oxirane, each of which are available from Angene International Limited, Nanjing, China; and (oxiran-2-ylmethyl)bis(prop-2-en-1-yl)amine, available from abcr GmbH, Germany.

In other embodiments, the unsaturated monofunctional epoxy compound has the general structure depicted above wherein n is three. Some illustrative compounds include for example (2,4,6-triallyl-phenoxymethyl)-oxirane, available from MOLBASE Bioechnology Co, Ltd.

In typical embodiments, n is no greater than 3.

In some embodiments, L is an alkylene group and R⁴ is a terminal carbon-carbon triple bond. The -L(R⁴)n group may be characterized as an alkyne. Some illustrative compounds include

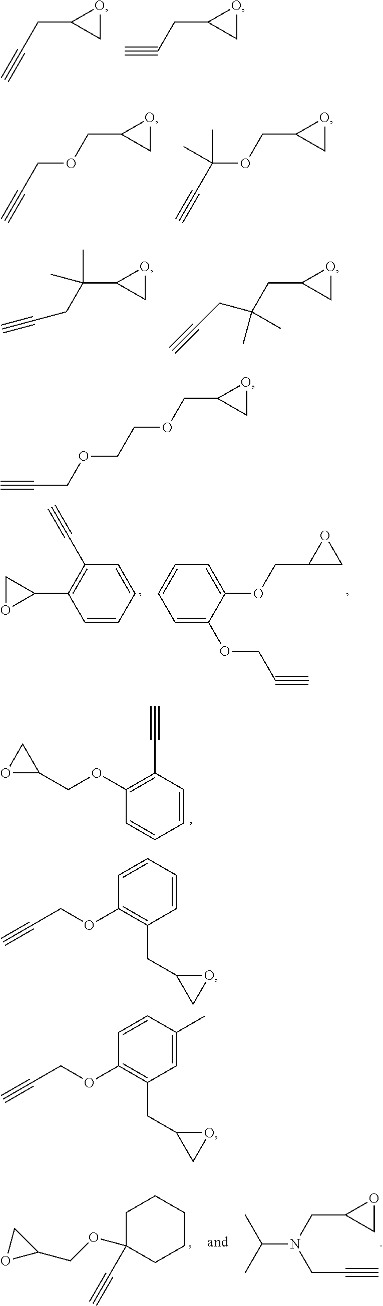

It is appreciated that the unsaturated monofunctional epoxy compound may comprise a combination of carbon-carbon double bonds and carbon-carbon triple bonds, such as in the case of the following compound

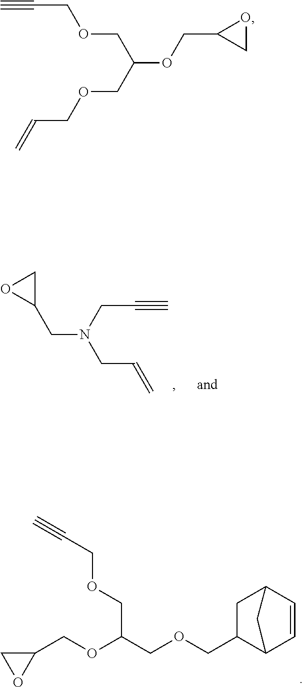 [SMILES: C#CCOCC(COCC=C)OCC1CO1 ; C#CCN(CC=C)CC1CO1 ; C#CCOCC(COCC1CC2C=CC1C2)OCC1CO1]

It is also appreciated that more than one unsaturated monofunctional epoxy compound can be reacted with the polyamine silicone ligand.

The -L(R⁴)n group is not a silicone ligand. Thus, the epoxy compound is not an epoxy-functional silicone ligand.

In some embodiments, the hydroxyl-functional unsaturated polyamine silicone ligand may be represented by the following structure:

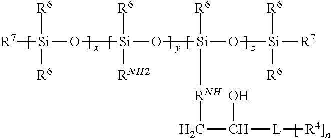

wherein
each R⁶ is independently alkyl, aryl, alkarylene, and aralkylene, typically having 1 to 30 carbon atoms;
R^{NH2} is an amine-substituted (hetero)hydrocarbyl group;
x is at least 1, 2 or 3 and ranges up to 2000;
y is 0 to 10;
z is 0 to 10;
n is at least 1;
L is a covalent bond or polyvalent linking group;
R⁴ is independently an unsaturated group, such as an alkenyl or alkynyl group; and
R⁷ is alkyl, aryl, R^{NH2}, or —NHCH₂CH(OH)L(R⁴)n; with the proviso that when z is 0, at least one R⁷ —NHCH₂CH(OH)L(R⁴)n, and when y is zero at least one R⁷ is R^{NH2}.

L and R⁴ are the same as previously described with respect to the monofunctional epoxy compound.

When y is at least 1 and z is at least 1, the hydroxyl-functional polyamine silicone ligand comprises a combination of one or more pendent primary amine groups and one or more pendent groups comprising a hydroxyl moiety and one or more unsaturated moieties. The pendent hydroxyl groups are derived from reacting some of the amine groups with the monofunctional epoxy compound.

In another embodiment, y is at least 1 and z is 0, at least one R⁷ is —NHCH₂CH(OH)L(R⁴)n. In this embodiment, the hydroxyl-functional unsaturated polyamine silicone ligand comprises pendent amine groups and one or more terminal groups having a hydroxyl moiety and unsaturated moiety, as depicted as follows:

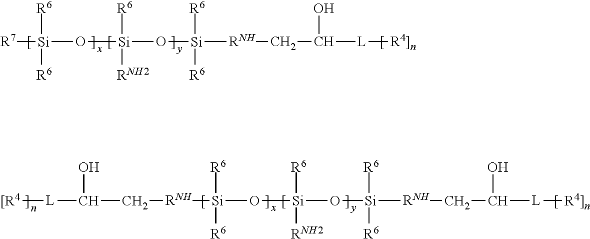

In another embodiment, y and z are each at least one, and at least one R⁷ is —NHCH₂CH(OH)L(R⁴)n. In this embodiment, the hydroxyl-functional and unsaturated polyamine silicone ligand may comprise both pendent and terminal groups having a hydroxyl moiety and unsaturated moiety, as depicted as follows:

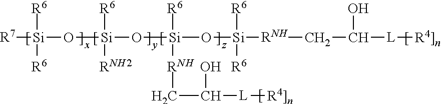

The amount of monofunctional epoxy compound is typically chosen such that the equivalent ratio of R^{NH2}to —NHCH₂CH(OH)L(R⁴)n ranges from 1 to 0.5 to 1 to 0.95. In some embodiments, the equivalent ratio of R^{NH2}to —NHCH₂CH(OH)L(R⁴)n is 1 to 0.6, 1 to 0.7, 1 to 0.8, or 1 to 0.9.

Such reaction results in at least 50 mole % of the —NH₂ (primary amine) groups being converted to a less reactive secondary amine that further comprises a hydroxyl group (—NHCH₂CH(OH)L(R⁴)n). Since L is derived from the monofunctional epoxy compound, the definition of L is the same as previously described.

Although the (e.g. weight average) molecular weight of the hydroxyl-functional polyamine silicone ligands and other silicone ligands can vary to some extent, in some embodiments, the molecular weight is typically no greater than 10,000 g/mole. In some embodiment, the (e.g. weight average) molecular weight of the polyamine silicone ligands is at least 1,000; 2,000; 3,000; 4,000 or 5,000 g/mole.

One representative hydroxyl-functional unsaturated polyamine silicone ligands is depicted as follows:

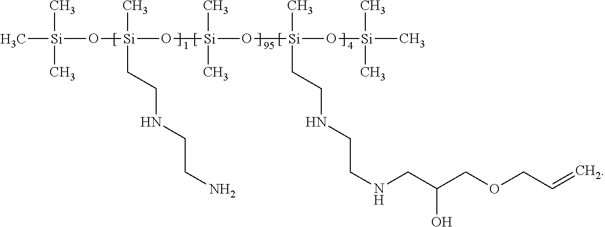

Other hydroxyl-functional unsaturated polyamine silicone ligands are depicted in the forthcoming examples.

The light-emitting nanoparticles further comprising a hydroxyl-functional unsaturated polyamine silicone ligand can be dispersed in a (e.g. liquid) polymerizable resin composition. Alternatively, hydroxyl-functional unsaturated polyamine silicone ligand can be added to the (e.g. liquid) polymerizable resin composition. The polymerizable resin composition may be characterized as a precursor of the polymeric binder or precursor of the cured matrix.

The amount of light-emitting nanoparticles in the polymerizable resin composition can vary. In some embodiments, the quantum dot composition comprises at least 0.1, 0.2, 0.3, 0.4, or 0.5 wt.-% of light-emitting nanoparticles and typically no greater than 5, 4, 4.5, 4, 3.5, 3, 2.5, 2, 1.5, or 1 wt.-%, based on the weight of the total quantum dot composition.

The amount of polyamine silicone ligand in the polymerizable resin composition is typically about 8×, 9×, or 10× the concentration of nanoparticles. Thus, the amount of hydroxyl-functional unsaturated polyamine silicone ligand (or mixture of silicone ligands including such) in the polymerizable resin is typically at least 0.5, 1, 2, 3, 4, or 5 wt.-% and no greater than 20, 15, or 10 wt.-% of the total quantum dot composition.

The quantum dot composition is typically substantially solvent-free. Thus, the concentration of (e.g. volatile) organic solvent is generally less than 1, 0.5 or 0.1 wt.-% of the total composition. In other embodiments, the composition may contain a non-volatile carrier fluid having a boiling point ≥100° C. or ≥150° C.

The (e.g. liquid) polymerizable resin composition described here further preferably comprises a polythiol and a polyene. The polythiol and polyene preferably both have a functionality of at least 2. Preferably at least one of the polythiol and polyene has a functionality of >2, such as 3 or greater.

The polythiol reactant in the thiol-ene resin is of the formula:

R²(SH)_{y}, III

where R² is polyvalent (hetero)hydrocarbyl group having a valence of y, and y is ≥2, preferably >2 (e.g. 3 or greater). The thiol groups of the polythiols may be primary or secondary. The compounds of Formula III may include a mixture of compounds having an average functionality of two or greater.

R² includes any (hetero)hydrocarbyl groups, including aliphatic (e.g. cycloaliphatic) and aromatic moieties having from 1 to 30 carbon atoms. R² may optionally further include one or more functional groups including pendent hydroxyl, acid, ester, or cyano groups or catenary (in-chain) ether, urea, urethane and ester groups.

In some embodiments, R² comprises a cyclic group such as an aromatic ring, a cycloaliphatic group, or a (iso)cyanurate group. The cyclic group can contribute to the cured polymerizable resin having a higher glass transition temperature (Tg) of at least 20° C. Non-aromatic cyclic groups typically provide better photostability than aromatic groups.

In one embodiment, the polythiol has the formula

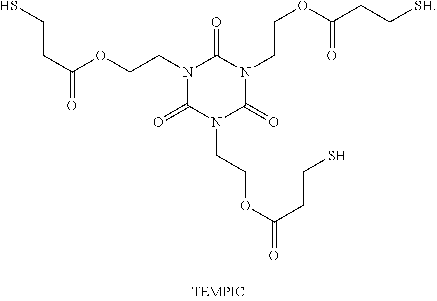 [SMILES: O=C(CCS)OCCn1c(=O)n(CCOC(=O)CCS)c(=O)n(CCOC(=O)CCS)c1=O]

Specific examples of other useful polythiols include 2,3-dimercapto-1-propanol, 2-mercaptoethyl ether, 2-mercaptoethyl sulfide, 1,6-hexanedithiol, 1,8-octanedithiol, 1,8-dimercapto-3,6-dithiaoctane, propane-1,2,3-trithiol, and trithiocyanuric acid.

Another useful class of polythiols includes those obtained by esterification of a polyol with a terminally thiol-substituted carboxylic acid (or derivative thereof, such as esters or acyl halides) including α- or β-mercaptocarboxylic acids such as thioglycolic acid, β-mercaptopropionic acid, 2-mercaptobutyric acid, or esters thereof.

Useful examples of commercially available compounds thus obtained include ethylene glycol bis(thioglycolate), pentaerythritol tetrakis(3-mercaptopropionate), dipentaerythritol hexakis(3-mercaptopropionate), ethylene glycol bis(3-mercaptopropionate), trimethylolpropane tris(thioglycolate), trimethylolpropane tris(3-mercaptopropionate), pentaerythritol tetrakis(thioglycolate), pentaerythritol tetrakis(3-mercaptopropionate), pentaerithrytol tetrakis (3-mercaptobutylate), and 1,4-bis 3-mercaptobutylyloxy butane, tris[2-(3-mercaptopropionyloxy]ethyl]isocyanurate, trimethylolpropane tris(mercaptoacetate), 2,4-bis(mercaptomethyl)-1,3,5,-triazine-2,4-dithiol, 2,3-di(2-mercaptoethyl)thio)-1-propanethiol, dimercaptodiethylsufide, and ethoxylated trimethylpropan-tri(3-mercaptopropionate).

In another embodiment, R² is polymeric and comprises a polyoxyalkylene, polyester, polyolefin, polyacrylate, or polysiloxane polymer having pendent or terminal reactive —SH groups. Useful polymers include, for example, thiol-terminated polyethylenes or polypropylenes, and thiol-terminated poly(alkylene oxides).

A specific example of a polymeric polythiol is polypropylene ether glycol bis(3-mercaptopropionate) which is prepared by esterification of polypropylene-ether glycol (e.g., Pluracol™ P201, BASF Wyandotte Chemical Corp.) and 3-mercaptopropionic acid by esterification.

Useful soluble, high molecular weight thiols include polyethylene glycol di(2-mercaptoacetate), LP-3™ resins supplied by Morton Thiokol Inc. (Trenton, N.J.), and Permapol P3™ resins supplied by Products Research & Chemical Corp. (Glendale, Calif.) and compounds such as the adduct of 2-mercaptoethylamine and caprolactam.

The curable quantum dot composition contains a polyene compound having at least two reactive ene groups including alkenyl and alkynyl groups. Such compounds are of the general formula:

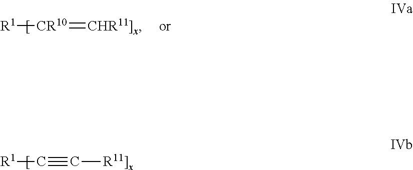

where
R¹ is a polyvalent (hetero)hydrocarbyl group,
each of R¹⁰ and R¹¹ are independently H or C₁-C₄ alkyl;
and x is ≥2. The compounds of Formula IVa may include vinyl ethers.

In some embodiments, R¹ is an aliphatic or aromatic group. R¹can be selected from alkyl groups of 1 to 20, 25 or 30 carbon atoms or aryl aromatic group containing 6-18 ring atoms. R¹ has a valence of x, where x is at least 2, preferably greater than 2. R¹ optionally contains one or more esters, amide, ether, thioether, urethane, or urea functional groups. The compounds of Formula IV may include a mixture of compounds having an average functionality of two or greater. In some embodiments, R¹⁰ and R¹¹ may form a ring.

In some embodiments, R¹ is a heterocyclic group. Heterocyclic groups include both aromatic and non-aromatic ring systems that contain one or more nitrogen, oxygen and sulfur heteroatoms. Suitable heteroaryl groups include furyl, thienyl, pyridyl, quinolinyl, tetrazolyl, imidazo, and triazinyl. The heterocyclic groups can be unsubstituted or substituted by one or more substituents selected from the group consisting of alkyl, alkoxy, alkylthio, hydroxy, halogen, haloalkyl, polyhaloalkyl, perhaloalkyl (e.g., trifluoromethyl), trifluoroalkoxy (e.g., trifluoromethoxy), nitro, amino, alkylamino, dialkylamino, alkylcarbonyl, alkenylcarbonyl, arylcarbonyl, heteroarylcarbonyl, aryl, arylalkyl, heteroaryl, heteroarylalkyl, heterocyclyl, heterocycloalkyl, nitrile and alkoxycarbonyl.

In some embodiments, the alkene compound is the reaction product of a mono- or polyisocyanate:

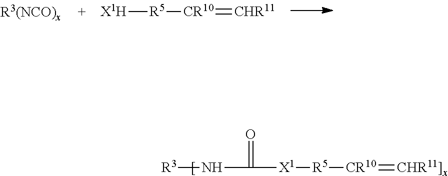

where
R³ is a (hetero)hydrocarbyl group;
X′ is —O—, —S— or —NR¹⁴—, where R¹⁴ is H of C₁-C₄ alkyl;
each of R¹⁰ and R¹¹ are independently H or C₁-C₄ alkyl;
R⁵ is a (hetero)hydrocarbyl group,
x is ≥2.

In particular, R⁵ may be alkylene, arylene, alkarylene, aralkylene, with optional in-chain heteroatoms. R⁵ can be selected from alkylene groups of 1 to 20 carbon atoms or aryl group containing 6-18 ring atoms. R⁵ has a valence of x, where x is at least 2, preferably greater than 2. R⁵ optionally contains one or more ester, amide, ether, thioether, urethane, or urea functional groups.

Polyisocyanate compounds useful in preparing the alkene compounds comprise isocyanate groups attached to the multivalent organic group that can comprise, in some embodiments, a multivalent aliphatic, alicyclic, or aromatic moiety (R³); or a multivalent aliphatic, alicyclic or aromatic moiety attached to a biuret, an isocyanurate, or a uretdione, or mixtures thereof. Preferred polyfunctional isocyanate compounds contain at least two isocyanate (—NCO) radicals. Compounds containing at least two —NCO radicals are preferably comprised of di- or trivalent aliphatic, alicyclic, aralkyl, or aromatic groups to which the —NCO radicals are attached.

Representative examples of suitable polyisocyanate compounds include isocyanate functional derivatives of the polyisocyanate compounds as defined herein. Examples of derivatives include, but are not limited to, those selected from the group consisting of ureas, biurets, allophanates, dimers and trimers (such as uretdiones and isocyanurates) of isocyanate compounds, and mixtures thereof. Any suitable organic polyisocyanate, such as an aliphatic, alicyclic, aralkyl, or aromatic polyisocyanate, may be used either singly or in mixtures of two or more.

The aliphatic polyisocyanate compounds generally provide better light stability than the aromatic compounds. Aromatic polyisocyanate compounds, on the other hand, are generally more economical and reactive toward nucleophiles than are aliphatic polyisocyanate compounds. Suitable aromatic polyisocyanate compounds include, but are not limited to, those selected from the group consisting of 2,4-toluene diisocyanate (TDI), 2,6-toluene diisocyanate, an adduct of TDI with trimethylolpropane (available as Desmodur™ CB from Bayer Corporation, Pittsburgh, Pa.), the isocyanurate trimer of TDI (available as Desmodur™ IL from Bayer Corporation, Pittsburgh, Pa.), diphenylmethane 4,4′-diisocyanate (MDI), diphenylmethane 2,4′-diisocyanate, 1,5-diisocyanato-naphthalene, 1,4-phenylene diisocyanate, 1,3-phenylene diisocyanate, 1-methyoxy-2,4-phenylene diisocyanate, 1-chlorophenyl-2,4-diisocyanate, and mixtures thereof.

Examples of useful alicyclic polyisocyanate compounds include, but are not limited to, those selected from the group consisting of dicyclohexylmethane diisocyanate (H₁₂ MDI, commercially available as Desmodur™ available from Bayer Corporation, Pittsburgh, Pa.), 4,4′-isopropyl-bis(cyclohexylisocyanate), isophorone diisocyanate (IPDI), cyclobutane-1,3-diisocyanate, cyclohexane 1,3-diisocyanate, cyclohexane 1,4-diisocyanate (CHDI), 1,4-cyclohexanebis(methylene isocyanate) (BDI), dimer acid diisocyanate (available from Bayer), 1,3-bis(isocyanatomethyl)cyclohexane (H₆ XDI), 3-isocyanatomethyl-3,5,5-trimethylcyclohexyl isocyanate, and mixtures thereof.

Examples of useful aliphatic polyisocyanate compounds include, but are not limited to, those selected from the group consisting of tetramethylene 1,4-diisocyanate, hexamethylene 1,4-diisocyanate, hexamethylene 1,6-diisocyanate (HDI), octamethylene 1,8-diisocyanate, 1,12-diisocyanatododecane, 2,2,4-trimethyl-hexamethylene diisocyanate (TMDI), 2-methyl-1,5-pentamethylene diisocyanate, dimer diisocyanate, the urea of hexamethylene diisocyanate, the biuret of hexamethylene 1,6-diisocyanate (HDI) (Desmodur™ N-100 and N-3200 from Bayer Corporation, Pittsburgh, Pa.), the isocyanurate of HDI (available as Desmodur™ N-3300 and Desmodur'N-3600 from Bayer Corporation, Pittsburgh, Pa.), a blend of the isocyanurate of HDI and the uretdione of HDI (available as Desmodur™ N-3400 available from Bayer Corporation, Pittsburgh, Pa.), and mixtures thereof.

Examples of useful aralkyl polyisocyanates (having alkyl substituted aryl groups) include, but are not limited to, those selected from the group consisting of m-tetramethyl xylylene diisocyanate (m-TMXDI), p-tetramethyl xylylene diisocyanate (p-TMXDI), 1,4-xylylene diisocyanate (XDI), 1,3-xylylene diisocyanate, p-(1-isocyanatoethyl)phenyl isocyanate, m-(3-isocyanatobutyl)phenyl isocyanate, 4-(2-isocyanatocyclohexyl-methyl)phenyl isocyanate, and mixtures thereof.

Preferred polyisocyanates, in general, include those selected from the group consisting of 2,2,4-trimethyl-hexamethylene diisocyanate (TMDI), tetramethylene 1,4-diisocyanate, hexamethylene 1,4-diisocyanate, hexamethylene 1,6-diisocyanate (HDI), octamethylene 1,8-diisocyanate, 1,12-diisocyanatododecane, mixtures thereof, and a biuret, an isocyanurate, or a uretdione derivatives.

In some embodiments, R¹ comprises a cyclic group such as an aromatic ring, a cycloaliphatic group, or a (iso)cyanurate group. The cyclic group can contribute to the cured polymerizable resin having a higher glass transition temperature (Tg) of at least 20° C. Non-aromatic cyclic groups typically provide better stability than aromatic groups.

In some preferred embodiments, the polyene is a cyanurate or isocyanurate of the formulas:

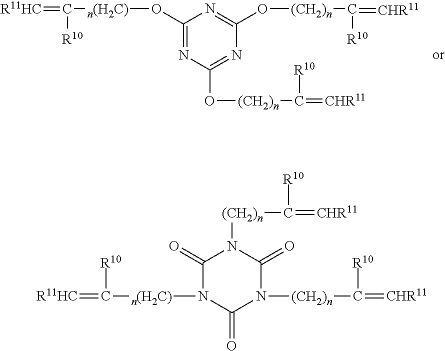

where n is at least one;
each of R¹⁰ and R¹¹ are independently H or C₁-C₄ alkyl.

The polyene compounds may be prepared as the reaction product of a polythiol compound and an epoxy-alkene compound. Similarly, the polyene compound may be prepared by reaction of a polythiol with a di- or higher epoxy compound, followed by reaction with an epoxy-alkene compound. Alternatively, a polyamino compound may be reacted with an epoxy-alkene compound, or a polyamino compound may be reacted a di- or higher epoxy compound, followed by reaction with an epoxy-alkene compound.

The polyene may be prepared by reaction of a bis-alkenyl amine, such a HN(CH₂CH═CH₂), with either a di- or higher epoxy compound, or with a bis- or high (meth)acrylate, or a polyisocyanate.

The polyene may be prepared by reaction of a hydroxy-functional polyalkenyl compound, such as (CH_{2═}CH—CH₂—O)ₙ—R—OH with a polyepoxy compound or a polyisocyanate.

An oligomeric polyene may be prepared by reaction between a hydroxyalkyl (meth)acrylate and an allyl glycidyl ether.

In some embodiments, the polyene comprises a combination of at least one compound according to Formula IVa (i.e. having alkene groups) and at least one compound according to Formula IVb (i.e. having alkyne groups).

In some preferred embodiments, the polyene and/or the polythiol compounds are oligomeric and prepared by reaction of the two with one in excess. For example, polythiols of Formula III may be reacted with an excess of polyenes of Formulas IVa and IVb such that an oligomeric polyene results having a functionality of at least two. Conversely an excess of polythiols of Formula IV may be reacted with the polyenes of Formulas IV a and IVb such that an oligomeric polythiol results having a functionality of at least two. The oligomeric polyenes and polythiols may be represented by the following formulas, where subscript z is two or greater. R¹, R², R¹⁰, R¹¹, y (of Formula III) and x (of Formula IV) are as previously defined.

In some embodiments, the polymerizable quantum dot composition comprises about 50 to 70 wt.-% polythiol and 15 to 35 wt.-% of polyene. However, other concentrations of polythiol and polyene can be used depending on the equivalent weight of selected components. The equivalent ratio of thiol (from polythiol) to ene (from polyene) can range from 1.3:1 to 1:1.3. In some embodiments, the equivalent ratio of thiol to ene ranges from 1:1 to 1.1:1.

In the following formulas, a linear thiol-ene polymer is shown for simplicity. It will be understood that the pendent ene group of the first polymer will have reacted with the excess thiol, and the pendent thiol groups of the second polymer will have reacted with the excess alkene. It will be understood that the corresponding alkynyl compounds may be used.

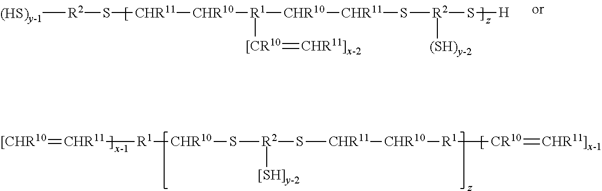

The polymerizable quantum dot composition may optionally further comprises an ethylenically unsaturated amine-reactive component. The amine reactive component typically comprises at least one ester group and one or more ethylenically unsaturated groups. The amine-reactive component is typically distinguished from the polyene in that the polyene is typically not amine-reactive and thus lacks an ester group.

Preferred amine reactive components can copolymerize with the polyene/and or polythiol during curing.

The amine-reactive ethylenically unsaturated component is typically a compound, monomer, or oligomer having a few repeat units such that the molecular weight (Mw) is less than 10,000 g/mole. In some embodiments, the amine-reactive ethylenically unsaturated component has a molecular weight (Mw) no greater than 5,000; 4,000; 3,000; 2,000 or 1,000 g/mole. The low molecular weight renders the components sufficient mobile in the composition in order to react with the excess amine (e.g. polyamine silicone ligand comprising unreacted amine groups). Suitable monomers include for example (meth)acrylates (i.e. acrylates and methacrylates), vinyl esters, and ally esters.

Without intending to be bound by theory it is surmised that the excess unbonded, free amine groups (—NH₂) of the polyamine silicone ligand in the quantum dot compositions may react with the ester-linkage (—CO(O)—) of the cured thiol-ene matrix resulting in degradation of the thiol-ene matrix, which reduces the lifetime of the quantum dot article. The inclusion of the hydroxyl-functional polyamine silicone ligand and optionally the addition of amine reactive ethylenically unsaturated component reduces the free amine Therefore, the amount of unreacted free amine groups in the quantum dot (e.g. coating) composition and corresponding the cured matrix can be minimized, especially at the interface between the quantum dot particles and matrix.

Without intending to be bound by theory it is surmised that the amine reactive group (e.g. ester) of the component reacts with the excess amine group of the composition. Therefore, the amount of unreacted amine groups in the composition can be minimized.

When present, the quantum dot (e.g. coating) composition generally comprises at least 1, 2, 3, 4, or 5 wt.-% of amine-reactive ethylenically unsaturated component, based on the total weight of the composition. The amount of amine-reactive ethylenically unsaturated component is typically no greater than 15 or 20 wt.-%.

Monomers with a single ethylenically unsaturated group can be used at low concentrations (e.g. no greater than 10 or 5 wt.-%). However, monomers with two or more ethylenically unsaturated groups can have little effect or even favorably increase the glass transition temperature (Tg) of the matrix (cured polymerizable resin composition). In some embodiments, the Tg of the matrix is greater than 20° C.

In some embodiments, the amine-reactive ethylenically unsaturated monomer is multifunctional, comprising at least 2 and typically no greater than 6 ethylenically unsaturated groups. In some embodiments, the amine-reactive ethylenically unsaturated monomer comprises an aromatic group, such as in the case of dially phthalate, such as available from TCI America under the trade designation “DAP”. In other embodiments, the amine-reactive ethylenically unsaturated monomer comprises an aliphatic group, such as in the case of triethylene glycol dimethacrylate, such as available from Sartomer under the trade designation “SR-205”.

Although aromatic and cyclic aliphatic groups can raise the Tg, aliphatic amine-reactive ethylenically unsaturated monomer generally provide better photostability. Other suitable difunctional (meth)acrylate monomers are known in the art, including for example 1,3-butylene glycol diacrylate, 1,4-butanediol diacrylate, 1,6-hexanediol diacrylate, 1,6-hexanediol monoacrylate monomethacrylate, ethylene glycol diacrylate, alkoxylated aliphatic diacrylate, alkoxylated cyclohexane dimethanol diacrylate, alkoxylated hexanediol diacrylate, alkoxylated neopentyl glycol diacrylate, caprolactone modified neopentylglycol hydroxypivalate diacrylate, caprolactone modified neopentylglycol hydroxypivalate diacrylate, cyclohexanedimethanol diacrylate, diethylene glycol diacrylate, dipropylene glycol diacrylate, ethoxylated bisphenol A diacrylate, neopentyl glycol diacrylate, polyethylene glycol diacrylate, (Mn=200 g/mole, 400 g/mole, 600 g/mole), propoxylated neopentyl glycol diacrylate, tetraethylene glycol diacrylate, tricyclodecanedimethanol diacrylate, triethylene glycol diacrylate, and tripropylene glycol diacrylate.

Other suitable higher functional (meth)acrylate monomers include for example pentaerythritol tri(meth)acrylate, pentaerythritol tetra(meth)acrylate, trimethylolpropane tri(methacrylate), dipentaerythritol penta(meth)acrylate, dipentaerythritol hexa(meth)acrylate, trimethylolpropane ethoxylate tri(meth)acrylate, glyceryl tri(meth)acrylate, pentaerythritol propoxylate tri(meth)acrylate, and ditrimethylolpropane tetra(meth)acrylate. Any one or combination of crosslinking agents may be employed.

The quantum dot composition optionally further comprises a hindered phenolic antioxidant. Sterically hindered phenols deactivate free radicals formed during oxidation of the quantum dots, ligands, or matrix materials. In some embodiments, the antioxidant comprises a thio-ether moiety. Useful hindered phenolic antioxidants include, for example:

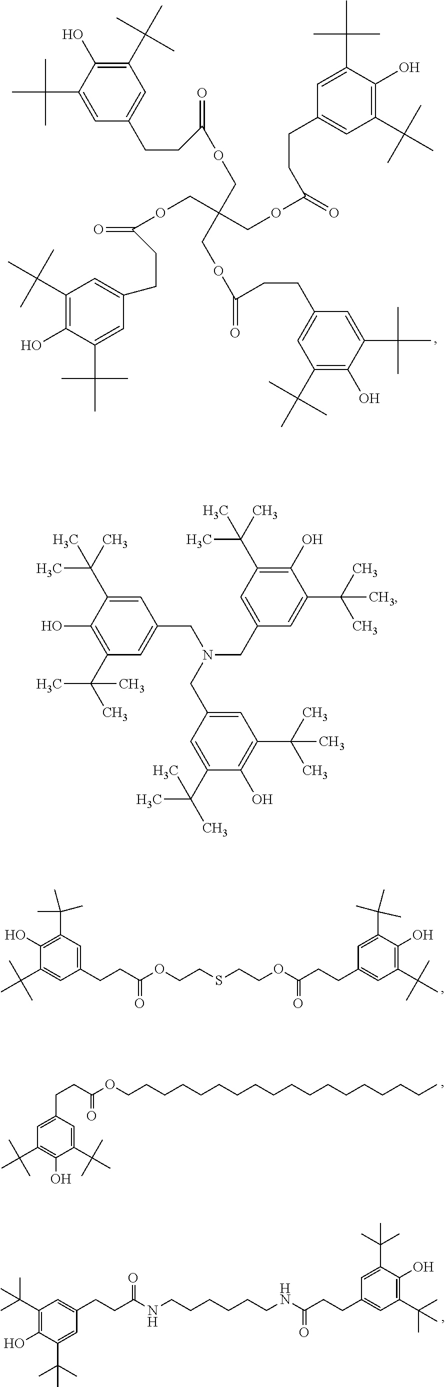

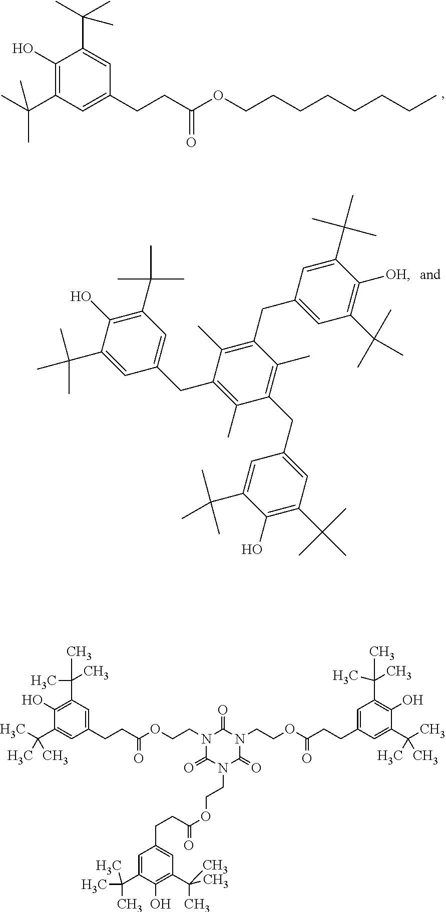

Hindered phenolic antioxidants are available from BASF under the trade name IRGANOX. Useful commercially available hindered phenolic antioxidants include IRGANOX 1010, IRGANOX 1035, IRGANOX 1076. IRGANOX 1098, IRGANOX 1135, IRGANOX 1330 and IRGANOX 3114.

Hindered phenolic antioxidants may also comprise curable reactive functional group which can be crosslinked with and locked in matrix or ligand in the cured articles. Some reactive antioxidants may also be pre-reacted with the ligand to concentrate around the quantum dots for better protection.

For matrixes containing UV-curable resin, the radical curable functional group attached on the hindered phenolic antioxidant may include, for example, enes selected acrylates, (meth)acrylates alkenes, alkynes or thiols. Representative examples of hindered phenolic antioxidants with UV-curable groups include:

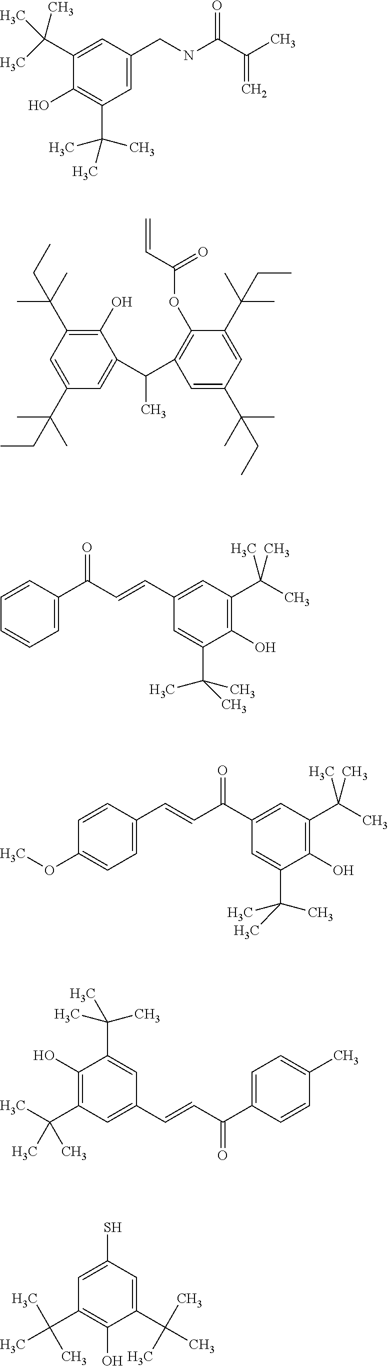

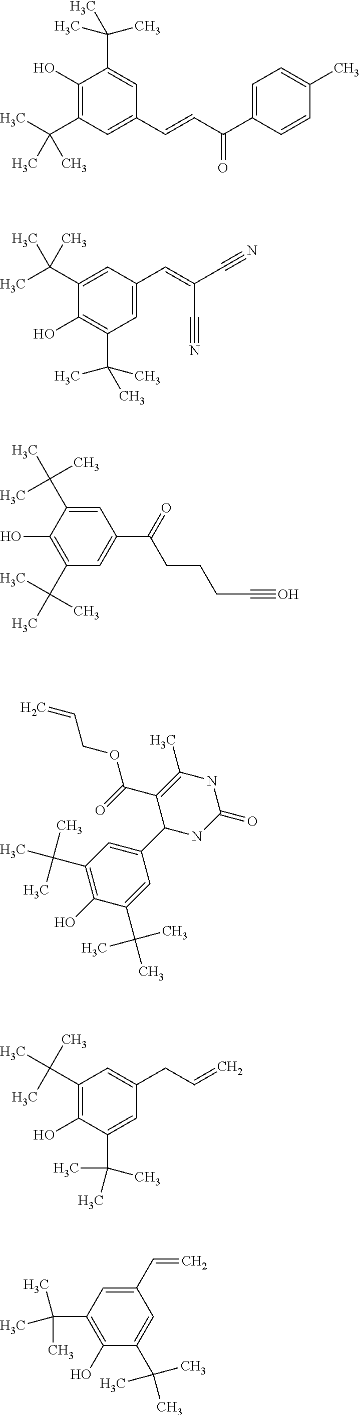

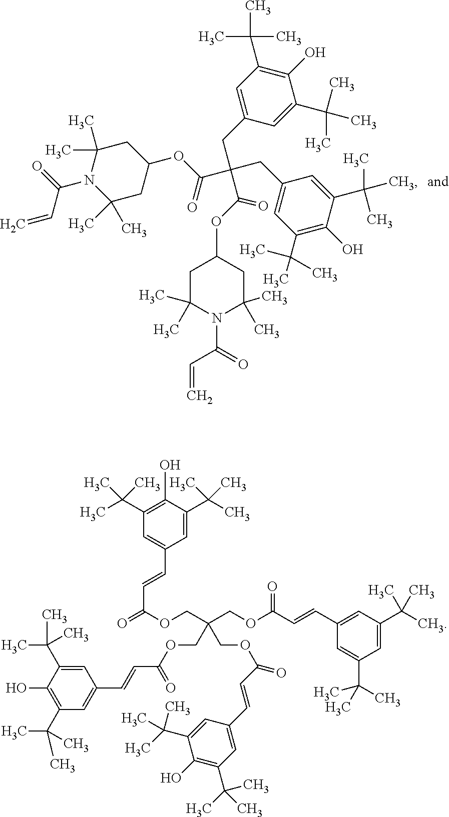 [SMILES: C=CC(=O)N1C(C)(C)CC(OC(=O)C(Cc2cc(C(C)(C)C)c(O)c(C(C)(C)C)c2)(Cc2cc(C(C)(C)C)c(O)c(C(C)(C)C)c2)C(=O)OC2CC(C)(C)N(C(=O)C=C)C(C)(C)C2)CC1(C)C ; CC(C)(C)c1cc(/C=C/C(=O)OCC(COC(=O)/C=C/c2cc(C(C)(C)C)c(O)c(C(C)(C)C)c2)(COC(=O)/C=C/c2cc(C(C)(C)C)c(O)c(C(C)(C)C)c2)COC(=O)/C=C/c2cc(C(C)(C)C)c(O)c(C(C)(C)C)c2)cc(C(C)(C)C)c1]

Hindered phenolic antioxidants with an acrylate group are available from BASF under the trade name IRGANOX 3052FF and from MAYZO under the trade name BNX 549 and BNX 3052.

Hindered phenolic antioxidant may include other functional groups such as amines, aldehyde, ketone and isothiolcyanate groups. The amine functionalized antioxidants may be pre-mixed with nanocrystals as co-ligands. Other functional groups may react with functional groups of components of the quantum dot composition, such as reaction with the amine group of polyamine silicone ligand, or polythiols and polyenes of the polymerizable resin. Representative examples include:

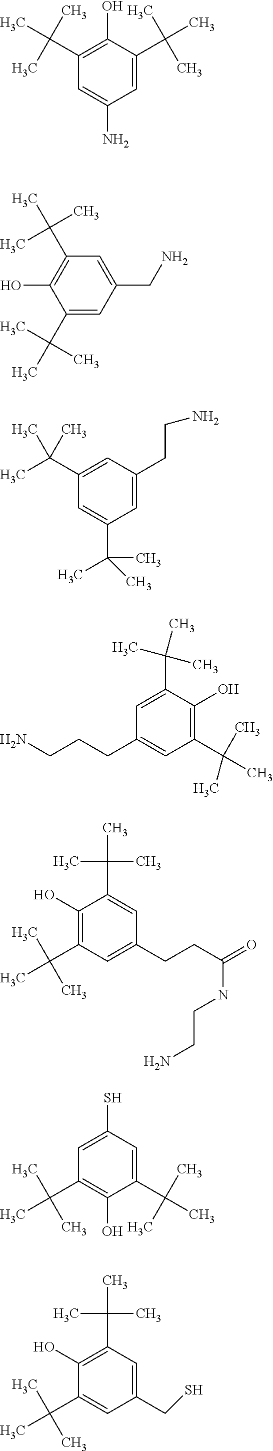

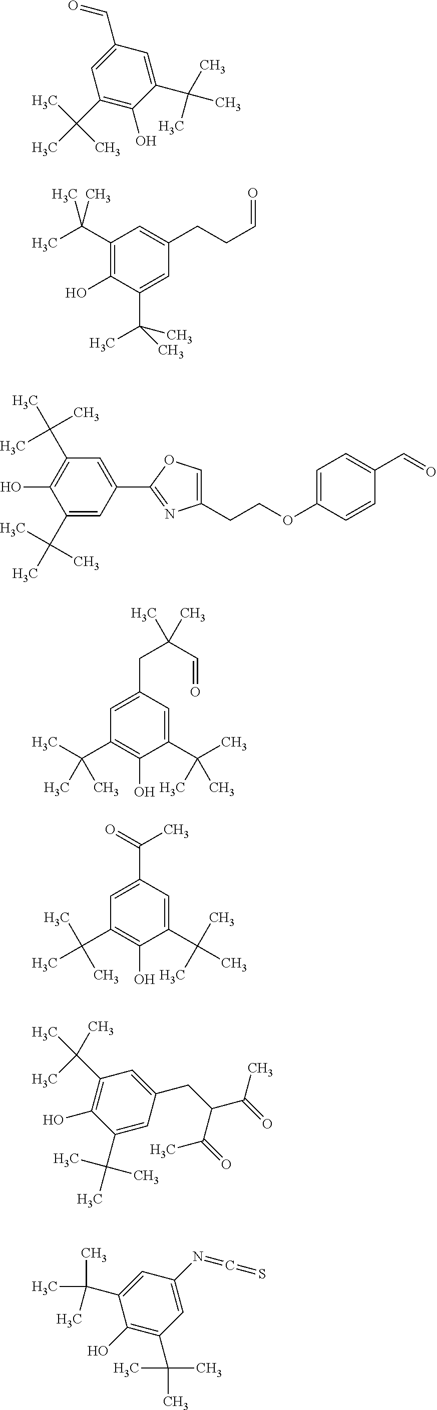

When present, the amount of antioxidant in the quantum dot composition is typically at least 0.1, 0.2, or 0.3 wt.-%, and typically no greater than 5 wt. %, based on the total weight of the quantum dot composition. In some embodiments, the amount of antioxidant is less than 4, 3, 2, or 1 wt.-%.

Preferred antioxidants have at least some compatibility (e.g. solubility) with polyamine silicone ligand or the polymerizable resin and cured thiol-ene matrix.

The quantum dot (e.g. coating) composition may be prepared by thoroughly mixing the components of the polymerizable resin composition including the polythiol, polyene, optional ethylenically unsaturated amine-reactive component, and optional antioxidant; and combining the polymerizable resin composition with the light-emitting nanoparticles that further comprise polyamine silicone ligand. The hydroxyl-functional polyamine silicone ligand can be added to the polymerizable resin composition and/or is present as a surface treatment on the light-emitting nanoparticles.

The antioxidant and amine-reactive ethylenically unsaturated component are typically pre-mixed with polyene. Alternatively, the amine-reactive ethylenically unsaturated component can pre-mixed with polyamine silicone ligand stabilized light-emitting nanoparticles and pre-reacted. In another embodiment, the amine-reactive ethylenically unsaturated component and polyamine silicone ligand can be pre-reacted, and then utilized as a surface treatment for the light-emitting nanoparticles.

The quantum dot composition may be free-radically thermally cured, radiation cured, or a combination thereof using a photo, thermal or redox initiator.

In some embodiments, the quantum dot composition is cured by exposure to actinic radiation such as UV light. The composition may be exposed to any form of actinic radiation, such as visible light or UV radiation, but is preferably exposed to UVA (320 to 390 nm) or UVV (395 to 445 nm) radiation. Generally, the amount of actinic radiation should be sufficient to form a solid mass that is not sticky to the touch. Generally, the amount of energy required for curing the compositions of the invention ranges from about 0.2 to 20.0 J/cm².

To initiate photopolymerization, the resin is placed under a source of actinic radiation such as a high-energy ultraviolet source having a duration and intensity of such exposure to provide for essentially complete (greater than 80%) polymerization of the composition contained in the molds. If desired, filters may be employed to exclude wavelengths that may deleteriously affect the reactive components or the photopolymerization. Photopolymerization may be affected via an exposed surface of the curable composition, or through the barrier layers as described herein by appropriate selection of a barrier film having the requisite transmission at the wavelengths necessary to effect polymerization.

Photoinitiation energy sources emit actinic radiation, i.e., radiation having a wavelength of 700 nanometers or less which is capable of producing, either directly or indirectly, free radicals capable of initiating polymerization of the thiol-ene compositions. Preferred photoinitiation energy sources emit ultraviolet radiation, i.e., radiation having a wavelength between about 180 and 460 nanometers, including photoinitiation energy sources such as mercury arc lights, carbon arc lights, low, medium, or high pressure mercury vapor lamps, swirl-flow plasma arc lamps, xenon flash lamps ultraviolet light emitting diodes, and ultraviolet light emitting lasers. Particularly preferred ultraviolet light sources are ultraviolet light emitting diodes available from Nichia Corp., Tokyo Japan, such as models NVSU233A U385, NVSU233A U404, NCSU276A U405, and NCSU276A U385.

In one embodiment, the initiator is a photoinitiator and is capable of being activated by UV radiation. Useful photoinitiators include e.g., benzoin ethers such as benzoin methyl ether and benzoin isopropyl ether, substituted benzoin ethers, substituted acetophenones such as 2,2-dimethoxy-2-phenylacetophenone, and substituted alpha-ketols. Examples of commercially available photoinitiators include Irgacure™ 819 and Darocur™ 1173 (both available form Ciba-Geigy Corp., Hawthorne, N.Y.), Lucem TPO™ (available from BASF, Parsippany, N.J.) and Irgacure™ 651, (2,2-dimethoxy-1,2-diphenyl-1-ethanone) which is available from Ciba-Geigy Corp. Preferred photoinitiators are ethyl 2,4,6-trimethylbenzoylphenyl phosphinate (Lucirin™ TPO-L) available from BASF, Mt. Olive, N.J., 2-hydroxy-2-methyl-1-phenyl-propan-1 -one (IRGACURE 1173™, Ciba Specialties), 2,2-dimethoxy-2-phenyl acetophenone (IRGACURE 651™, Ciba Specialties), phenyl bis(2,4,6-trimethyl benzoyl)phosphine oxide (IRGACURE 819, Ciba Specialties). Other suitable photoinitiators include mercaptobenzothiazoles, mercaptobenzooxazoles and hexaryl bisimidazole.

Examples of suitable thermal initiators include peroxides such as benzoyl peroxide, dibenzoyl peroxide, dilauryl peroxide, cyclohexane peroxide, methyl ethyl ketone peroxide, hydroperoxides, e.g., tert-butyl hydroperoxide and cumene hydroperoxide, dicyclohexyl peroxydicarbonate, 2,2,-azo-bis(isobutyronitrile), and t-butyl perbenzoate. Examples of commercially available thermal initiators include initiators available from DuPont Specialty Chemical (Wilmington, Del.) under the VAZO trade designation including VAZO™64 (2,2′-azo-bis(isobutyronitrile)) and VAZO™ 52, and Lucidol™ 70 from Elf Atochem North America, Philadelphia, Pa.

The quantum dot composition may also be polymerized using a redox initiator system of an organic peroxide and a tertiary amine Reference may be made to Bowman et al., Redox Initiation of Bulk Thiol-alkene Polymerizations, Polym. Chem., 2013, 4, 1167-1175, and references therein.

Generally, the amount of initiator (e.g. photoiniator) is less than 5, 4, 3, 2, or 1 wt. %. In some embodiments, there is no added free radical initiator. In other embodiments, the amount of initiator (e.g. photoiniator) is at least 0.1, 0.2, 0.3, or 0.4 wt. %.

If desired, a stabilizer or inhibitor may be added to the composition to control the rate of reaction. The stabilizer can be for example N-nitroso compounds described in U.S. Pat. No. 5,358,976 (Dowling et al.) and in U.S. Pat. No. 5,208,281 (Glaser et al.), and the alkenyl substituted phenolic compounds described in U.S. Pat. No. 5,459,173 (Glaser et al.).

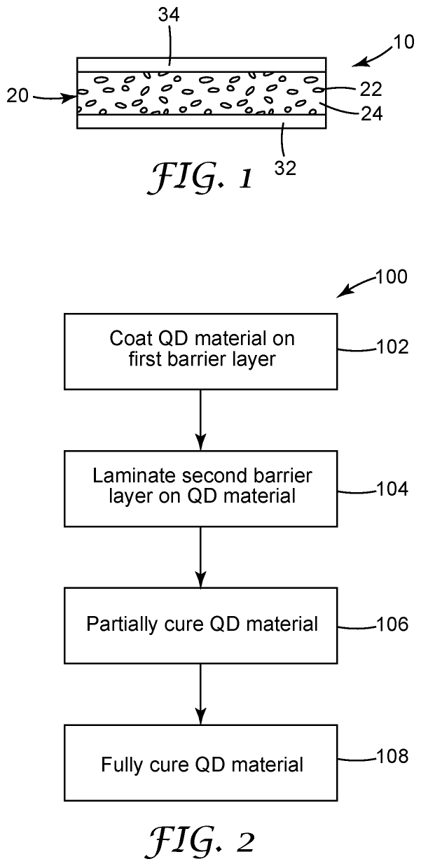

Referring to FIG. 1, quantum dot article 10 includes a first barrier layer 32, a second barrier layer 34, and a quantum dot layer 20 between the first barrier layer 32 and the second barrier layer 34. The quantum dot layer 20 includes a plurality of quantum dot/polyamine silicone ligand nanoparticles 22 dispersed in a matrix 24.

The barrier layers 32, 34 can be formed of any useful material that can protect the quantum dots 22 from exposure to environmental contaminates such as, for example, oxygen, water, and water vapor. Suitable barrier layers 32, 34 include, but are not limited to, films of polymers, glass and dielectric materials. In some embodiments, suitable materials for the barrier layers 32, 34 include, for example, polymers such as polyethylene terephthalate (PET); oxides such as silicon oxide, titanium oxide, or aluminum oxide (e.g., SiO₂, Si₂O₃, TiO₂, or Al₂O₃); and suitable combinations thereof.

More particularly, barrier films can be selected from a variety of constructions. Barrier films are typically selected such that they have oxygen and water transmission rates at a specified level as required by the application. In some embodiments, the barrier film has a water vapor transmission rate (WVTR) less than about 0.005 g/m²/day at 38° C. and 100% relative humidity; in some embodiments, less than about 0.0005 g/m²/day at 38° C. and 100% relative humidity; and in some embodiments, less than about 0.00005 g/m²/day at 38° C. and 100% relative humidity.

Exemplary useful barrier films include inorganic films prepared by atomic layer deposition, thermal evaporation, sputtering, and chemical vapor deposition. Useful barrier films are typically flexible and transparent. In some embodiments, useful barrier films comprise inorganic/organic. Flexible ultra-barrier films comprising inorganic/organic multilayers are described, for example, in U.S. Pat. No. 7,018,713 (Padiyath et al.). Such flexible ultra-barrier films may have a first polymer layer disposed on polymeric film substrate that is overcoated with two or more inorganic barrier layers separated by at least one second polymer layer. In some embodiments, the barrier film comprises one inorganic barrier layer interposed between the first polymer layer disposed on the polymeric film substrate and a second polymer layer.

In some embodiments, each barrier layer 32, 34 of the quantum dot article 10 includes at least two sub-layers of different materials or compositions. In some embodiments, such a multi-layered barrier construction can more effectively reduce or eliminate pinhole defect alignment in the barrier layers 32, 34, providing a more effective shield against oxygen and moisture penetration into the matrix 24. The quantum dot article 10 can include any suitable material or combination of barrier materials and any suitable number of barrier layers or sub-layers on either or both sides of the quantum dot layer 20. The materials, thickness, and number of barrier layers and sub-layers will depend on the particular application, and will suitably be chosen to maximize barrier protection and brightness of the quantum dots 22 while minimizing the thickness of the quantum dot article 10. In some embodiments, each barrier layer 32, 34 is itself a laminate film, such as a dual laminate film, where each barrier film layer is sufficiently thick to eliminate wrinkling in roll-to-roll or laminate manufacturing processes. In one illustrative embodiment, the barrier layers 32, 34 are polyester films (e.g., PET) having an oxide layer on an exposed surface thereof.

The quantum dot layer 20 can include one or more populations of quantum dots or quantum dot materials 22. Exemplary quantum dots or quantum dot materials 22 emit green light and red light upon down-conversion of blue primary light from a blue LED to secondary light emitted by the quantum dots. The respective portions of red, green, and blue light can be controlled to achieve a desired white point for the white light emitted by a display device incorporating the quantum dot article 10. Exemplary quantum dots 22 for use in the quantum dot articles 10 include, but are not limited to, InP or CdSe with ZnS shells. Suitable quantum dots for use in quantum dot articles described herein include, but are not limited to, core/shell luminescent nanocrystals including CdSe/ZnS, InP/ZnS, PbSe/PbS, CdSe/CdS, CdTe/CdS or CdTe/ZnS. In exemplary embodiments, the luminescent nanocrystals include an outer ligand coating and are dispersed in a polymeric matrix. Quantum dot and quantum dot materials 22 are commercially available from, for example, Nanosys Inc., Milpitas, Calif. The quantum dot layer 20 can have any useful amount of quantum dots 22, and in some embodiments the quantum dot layer 20 can include from 0.1 wt % to 5 wt % quantum dots, based on the total weight of the quantum dot layer 20.

In one or more embodiments the quantum dot layer 20 can optionally include scattering beads or particles. These scattering beads or particles have a refractive index that differs from the refractive index of the matrix material 24 by at least 0.05, or by at least 0.1. These scattering beads or particles can include, for example, polymers such as silicone, acrylic, nylon, and the like, or inorganic materials such as TiO₂, SiOₓ, AlOₓ, and the like, and combinations thereof. In some embodiments, including scattering particles in the quantum dot layer 20 can increase the optical path length through the quantum dot layer 20 and improve quantum dot absorption and efficiency. In many embodiments, the scattering beads or particles have an average particle size from 1 to 10 micrometers, or from 2 to 6 micrometers. In some embodiments, the quantum dot material 20 can optionally include fillers such fumed silica.

In some preferred embodiments, the scattering beads or particles are Tospearl™ 120A, 130A, 145A and 2000B spherical silicone resins available in 2.0, 3.0, 4.5 and 6.0 micron particle sizes respectively from Momentive Specialty Chemicals Inc., Columbus, Ohio.

The matrix 24 of the quantum dot layer 20 is formed from the cured quantum dot composition described herein forming the barrier layers 32, 34 to form a laminate construction, and also forms a protective matrix for the quantum dots 22.

Referring to FIG. 2, one suitable method of forming a quantum dot film article 100 includes coating a composition including quantum dots on a first barrier layer 102 and disposing a second barrier layer on the quantum dot material 104. In some embodiments, the method 100 includes polymerizing (e.g., radiation curing) the quantum dot composition described herein to form a fully- or partially cured quantum dot material 106 and optionally thermally polymerizing the binder composition to form a cured polymeric binder 108.

In various embodiments, the thickness of the quantum dot layer 20 is about 50 microns to about 250 microns.

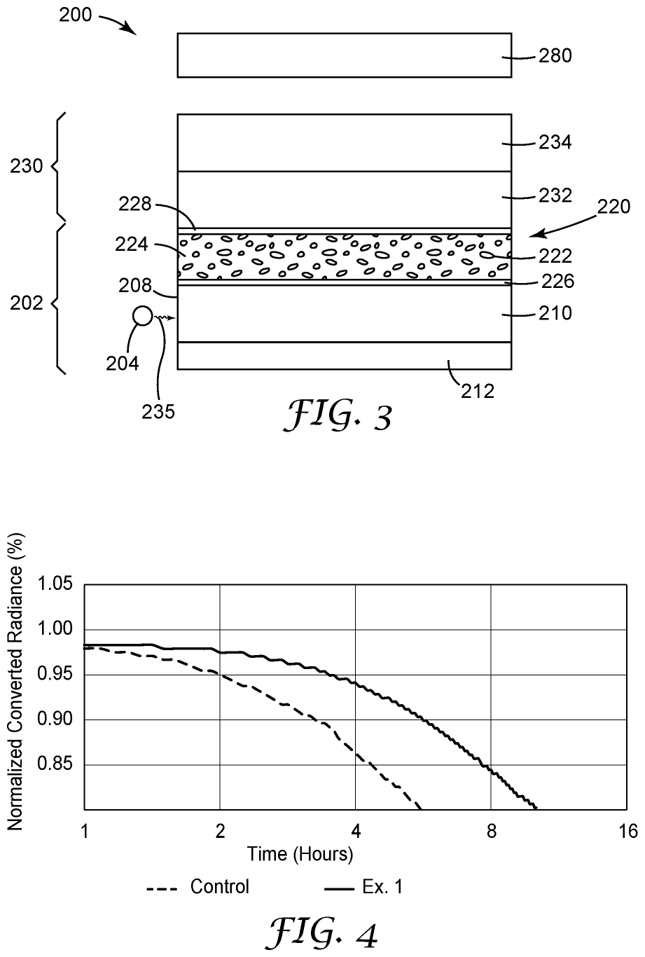

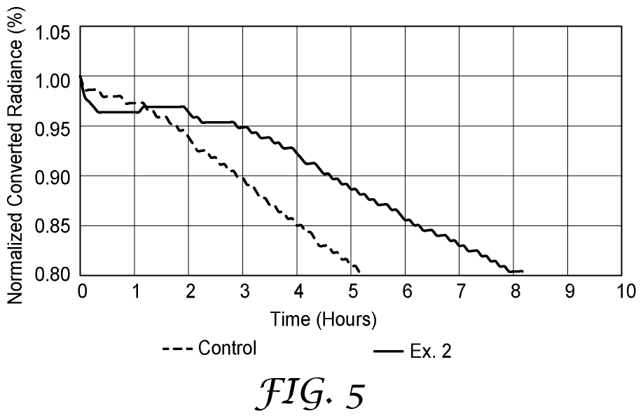

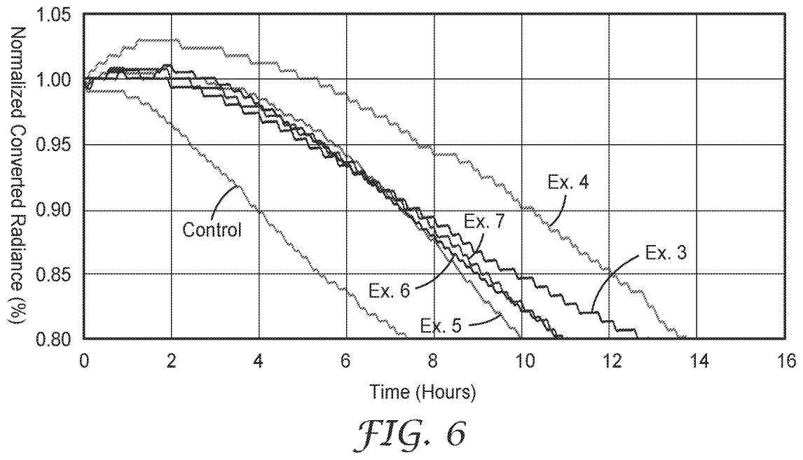

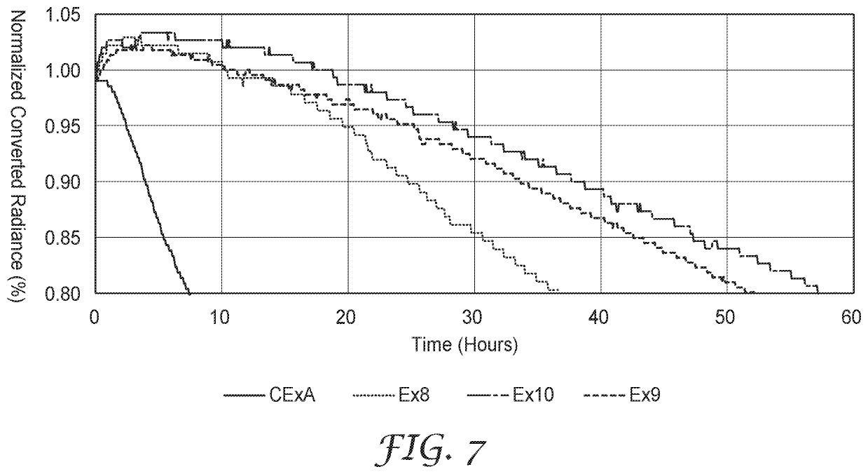

FIG. 3 is a schematic illustration of an embodiment of a display device 200 including the quantum dot articles described herein. This illustration is merely provided as an example and is not intended to be limiting. The display device 200 includes a backlight 202 with a light source 204 such as, for example, a light emitting diode (LED). The light source 204 emits light along an emission axis 235. The light source 204 (for example, a LED light source) emits light through an input edge 208 into a hollow light recycling cavity 210 having a back reflector 212 thereon. The back reflector 212 can be predominately specular, diffuse or a combination thereof, and is preferably highly reflective. The backlight 202 further includes a quantum dot article 220, which includes a protective matrix 224 having dispersed therein quantum dots 222. The protective matrix 224 is bounded on both surfaces by polymeric barrier films 226, 228, which may include a single layer or multiple layers.

The display device 200 further includes a front reflector 230 that includes multiple directional recycling films or layers, which are optical films with a surface structure that redirects off-axis light in a direction closer to the axis of the display, which can increase the amount of light propagating on-axis through the display device, this increasing the brightness and contrast of the image seen by a viewer. The front reflector 230 can also include other types of optical films such as polarizers. In one non-limiting example, the front reflector 230 can include one or more prismatic films 232 and/or gain diffusers. The prismatic films 232 may have prisms elongated along an axis, which may be oriented parallel or perpendicular to an emission axis 235 of the light source 204. In some embodiments, the prism axes of the prismatic films may be crossed. The front reflector 230 may further include one or more polarizing films 234, which may include multilayer optical polarizing films, diffusely reflecting polarizing films, and the like. The light emitted by the front reflector 230 enters a liquid crystal (LC) panel 280. Numerous examples of backlighting structures and films may be found in, for example, U.S. Pat. No. 8,848,132 (O'Neill et al.).

The lifetime of the quantum dot film of the invention upon accelerated aging is greatly increased as compared to quantum dot film elements without both the hindered phenolic antioxidant and the amine-reactive ethylenically unsaturated component, or with only a hindered phenolic antioxidant but lacking the amine-reactive ethylenically unsaturated component, or with only the amine-reactive ethylenically unsaturated component but lacking the hindered phenolic antioxidant. In one embodiment, the lifetime of the quantum dot film (i.e. cured quantum dot composition) is increased such that when it is illuminated by a single pass of 10,000 mW/cm² of 450 nm blue light at 50° C. the normalized converted radiance is greater than 85% of its initial value for at least 5 hours.

In other embodiments, the normalized converted radiance is greater than 85% of its initial value for at least 10, 15, 20, 25, 30, 35, 40 hours or greater when it is illuminated by a single pass of 10,000 mW/cm² of 495 nm blue light at 50° C. The normalized converted radiance is determined according to the test method described in the examples.

In one embodiment, the quantum yield (EQE) of the quantum dot film is at least 85%, 90%, 95% or greater of its initial value after 1 week at 85° C.

Ingress, including edge ingress, is defined by a loss in quantum dot performance due to ingress of moisture and/or oxygen into the matrix. In various embodiments, the edge ingress of moisture and oxygen into the cured matrix is less than about 1.0 mm after 1 week at 85° C., or about less than 0.75 mm after 1 week at 85° C., or less than about 0.5 mm after 1 week at 85° C. or less than 0.25 mm after 1 week at 85° C. In various embodiments the matrix has a moisture and oxygen ingress of less than about 0.5 mm after 500 hours at 65° C. and 95% relative humidity.

The quantum dot articles of the invention can be used in display devices. Such display devices can include, for example, a backlight with a light source such as, for example, a LED. The light source emits light along an emission axis. The light source (for example, a LED light source) emits light through an input edge into a hollow light recycling cavity having a back reflector thereon. The back reflector can be predominately specular, diffuse or a combination thereof, and is preferably highly reflective. The backlight further includes a quantum dot article, which includes a protective matrix having dispersed therein quantum dots. The protective matrix is bounded on both surfaces by polymeric barrier films, which may include a single layer or multiple layers.

The display device can further include a front reflector that includes multiple directional recycling films or layers, which are optical films with a surface structure that redirects off-axis light in a direction closer to the axis of the display. In some embodiments, the directional recycling films or layers can increase the amount of light propagating on-axis through the display device, this increasing the brightness and contrast of the image seen by a viewer. The front reflector can also include other types of optical films such as polarizers. In one non-limiting example, the front reflector can include one or more prismatic films and/or gain diffusers. The prismatic films may have prisms elongated along an axis, which may be oriented parallel or perpendicular to an emission axis of the light source. In some embodiments, the prism axes of the prismatic films may be crossed. The front reflector may further include one or more polarizing films, which may include multilayer optical polarizing films, diffusely reflecting polarizing films, and the like. The light emitted by the front reflector enters a liquid crystal (LC) panel. Numerous examples of backlighting structures and films may be found in, for example, U.S. Published Application No. US 2011/0051047.

As used herein

“thiol-ene” refers to the reaction mixture of a polythiol and a polyalkene compound having two or more alkenyl or alkynyl groups.

“Alkyl” means a linear or branched, cyclic or acylic, saturated monovalent hydrocarbon.

“Alkylene” means a linear or branched unsaturated divalent hydrocarbon.

“Alkenyl” means an unsaturated hydrocarbon having a carbon-carbon double bond.

“Alkynyl” means an unsaturated hydrocarbon having a carbon-carbon triple bond.

“Aryl” means a monovalent aromatic, such as phenyl, naphthyl and the like.

“Arylene” means a polyvalent, aromatic, such as phenylene, naphthalene, and the like.

“Aralkylene” means a group defined above with an aryl group attached to the alkylene, e.g., benzyl, 1-naphthylethyl, and the like.

“Aralkylene” means a group defined above with an alkyl group attached to an arylene. As used herein, “(hetero)hydrocarbyl” is inclusive of hydrocarbyl alkyl and aryl groups, and heterohydrocarbyl heteroalkyl and heteroaryl groups, the later comprising one or more catenary (in-chain) heteroatoms such as ether or amino groups. Heterohydrocarbyl may optionally contain one or more catenary (in-chain) functional groups including ester, amide, urea, urethane, and carbonate functional groups. Unless otherwise indicated, the non-polymeric (hetero)hydrocarbyl groups typically contain from 1 to 60 carbon atoms, unless specified otherwise.

### EXAMPLES

Objects and advantages of this invention are further illustrated by the following examples, but the particular materials and amounts thereof recited in these examples, as well as other conditions and details, should not be construed to unduly limit this invention.

All parts, percentages, ratios, etc. in the examples and the rest of the specification are by weight, unless noted otherwise. Solvents and other reagents used were obtained from Sigma-Aldrich Chemical Company, St. Louis, Mo., unless otherwise noted.

### Materials

TABLE 1

| Material | Description |
|---|---|
| Barrier Film | Primed PET barrier film, 2-mil (50 micrometer) barrier film obtained as |
| | FTB-M-50 from 3M, St. Pau, MN |
| R-QD | Red quantum dots with (80-90 wt.-%) amino-silicone ligands |
| | (QCEF62290R2-01), available from Nanosys Corp., Milpitas CA |
| G-QD | Green quantum dot with (80-90 wt.-%) amino-silicone ligands |
| | (QCEF53040R2-01), available from Nanosys Corp., Milpitas CA |
| AGE | Allyl glycidyl ether [CAS# 106-92-3], available from Alfa Aesar, |
| | Haverhill, MA |
| EP-6-E | 1,2-Epoxy-5-hexene [CAS# 10353-53-4], available from Aldrich, |
| | Milwaukee, WI |
| EP-8-E | 1,2-Epoxy-7-octene [CAS# 19600-63-6], available from Alfa Aesar, |
| | Haverhill, MA |
| EP-10-E | 1,2-Epoxy-9-decene [CAS# 85721-25-1], available from TCI America, |
| | Portland, OR |
| GP988 | amino-silicone, available from Genesee Polymers Co., Burton, MI |
| TPO-L | Ethyl-2,4,6-trimethylbenzoylphenylphosphinate, a liquid UV initiator, |
| | available from BASF Resins Wyandotte, MI under trade designation |
| | “LUCIRIN TPO-L” |
| TEMPIC | 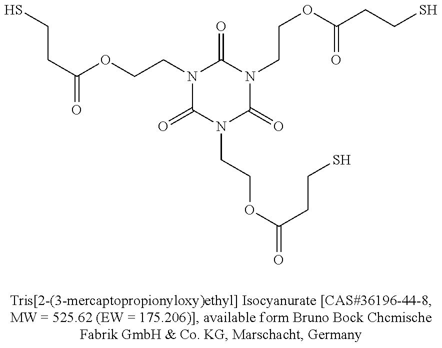 [SMILES: O=C(CCS)OCCn1c(=O)n(CCOC(=O)CCS)c(=O)n(CCOC(=O)CCS)c1=O] |
| TAIC | 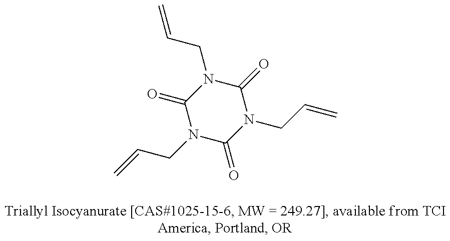 [SMILES: C=CCn1c(=O)n(CC=C)c(=O)n(CC=C)c1=O] |
| AO-1 | 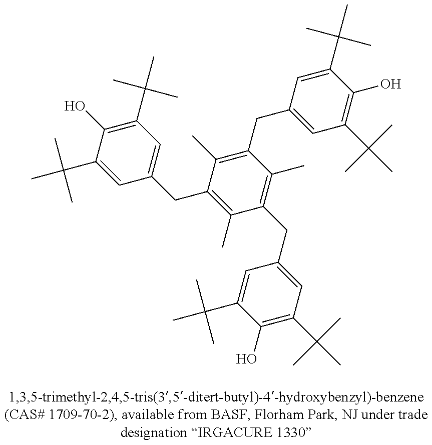 [SMILES: Cc1c(Cc2cc(C(C)(C)C)c(O)c(C(C)(C)C)c2)c(C)c(Cc2cc(C(C)(C)C)c(O)c(C(C)(C)C)c2)c(C)c1Cc1cc(C(C)(C)C)c(O)c(C(C)(C)C)c1] |
| AO-2 | 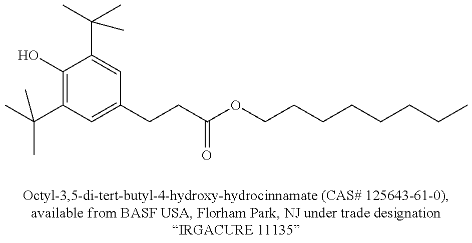 [SMILES: CCCCCCCCOC(=O)CCc1cc(C(C)(C)C)c(O)c(C(C)(C)C)c1] |

All other reagents and chemicals were obtained from standard chemical suppliers and were used as received.

### Test Methods

### Quantum Yield (EQE) Measurement

All quantum yields (EQE) were measured using a Hamamatsu Quantaurus QY, absolute PL Quantum Yield Spectrometer C11347.

### Method for Thermal Aging

Thermal aging was conducted by aging the cut films samples prepared as described in Examples and Comparative Examples below in an 85° C. oven for 7 days. Then, EQE and edge ingress were measured on the aged samples for assessing the aging stability.

In a variant of this method the thermal aging was conducted by aging the cut films samples prepared as described in Examples and Comparative Examples below in a 50° C. oven for 7, 14 and 24 days. Then, EQE and edge ingress were measured on the aged samples for assessing the aging stability.

### Method for Determining Edge Ingress

The edge ingress of the cured matrix with two barrier films was measured from a cut edge of a matrix film by a ruler under a magnifier after it was aged as described above. The quantum dots at the edge exhibited a black-line under a blue light if the quantum dots were degraded by oxygen and/or moisture during the aging and were not emitting green and/or red light. The edge ingress number indicates how deep the quantum dots from the cut edge has been degraded.

### Accelerated Super High Intensity Light Test (SHILT)

An in-house light acceleration box for accelerated aging test was designed to provide independent blue flux (495 nm) and controlled temperature (50° C.) by creating physical separation of the light source and sample chamber. The walls and bottom of the light box are lined with a reflective metal material (Anolux Miro-Silver manufactured by Anomet, Ontario, Canada) to provide light recycling. A ground glass diffuser was placed over the LEDs to improve the illumination uniformity (Haze level). The sample chamber is temperature controlled with a forced air creating constant temperature air flow over the sample surfaces. This system is set at 50° C. and the incident blue flux of 10,000 mW/cm². In addition, a sapphire window was added to the sample holder to sandwich the sample and offer a direct path to the sample for temperature control. This enabled us to control temperature even with the elevated incident fluxes.

An approximately 3×3.5inch (7.5 cm×8.9 cm) test specimen was placed directly on the glass diffuser. A metal reflector (Anolux Miro-Silver) was then placed over the samples to simulate recycling in a typical LED backlight. The sample temperature was maintained at about 50° C. using air flow and heat sinks.

The samples were considered to have failed when the normalized EQE or brightness drops to 85% of the initial value.

### Method for Determining % Lifetime Improvement

Life time (LT) of samples prepared according to Examples and Comparative Examples described below were determined from SHILT data assuming that the samples failed at 85% normalized converted radiance.

LT Improvement and % LT Improvement for samples prepared according to Examples described below were determined relative to the corresponding Comparative Example sample using the formulas summarized below:

% LT Improvement=[(LT)s−(LT)c]/(LT)c×100%

LT Improvement=(LT)s/(LT)c

### Wherein:

(LT)s is the lifetime of an Exemplary sample
(LT)c is the lifetime of a corresponding Comparative Example sample.

### Preparative Example 1 (PEx1)

### Preparation of AGE Modified Polyamine-Silicone, AGE/GP988

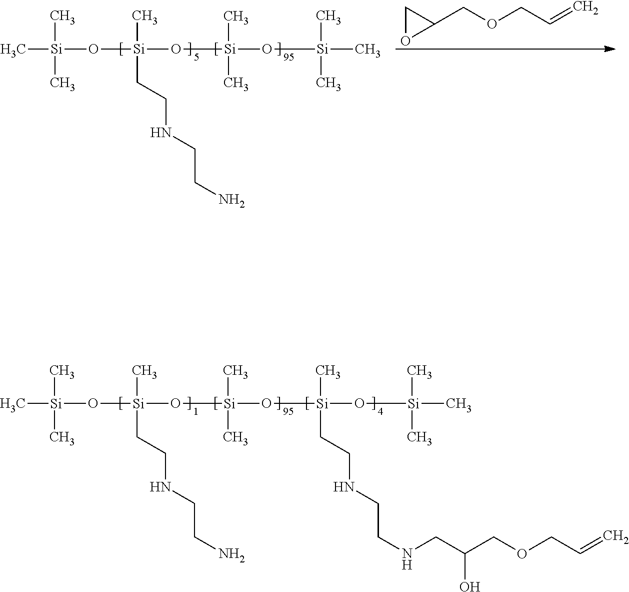

32.0 g GP988 (˜20.0 meq) and 1.83 g AGE (16.03 meq), corresponding to an equivalent ratio of —NH₂ to epoxide of about 1 to 0.8, were charged in a 50 mL bottle. The heterogeneous solution was mixed and heated to 80° C. for 0.5 hour with a magnetic stirrer, and a homogeneous and clear solution was obtained. The completion of the reaction was confirmed by FTIR analysis.

### Preparative Example 2 (PEx2)

### EP-8-E Modified Polyamine-Silicone, EP-8-E/GP988

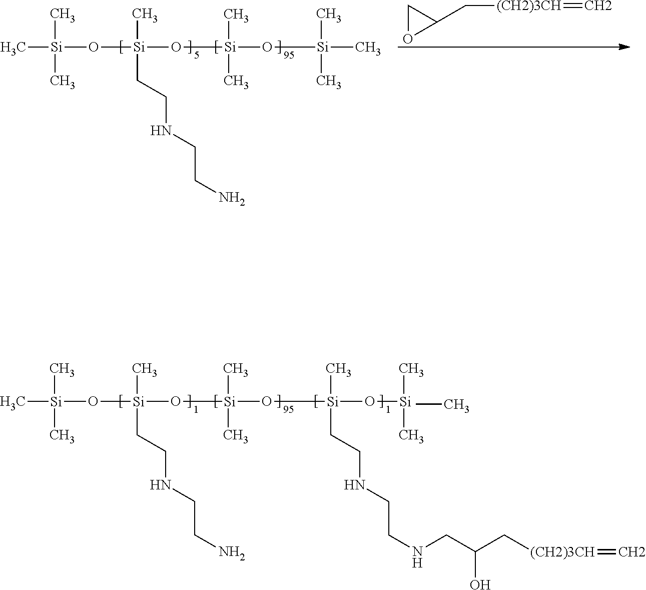

PEx2 was prepared in the same manner as PEx1 except that 20.1 g GP988 (˜12.6 meq) and 1.29 g EP-8-E (˜10.22 meq), corresponding to an equivalent ratio of —NH₂ to epoxide of about 1 to 0.8, was used.

### Preparative Example 3 (PEx3)

### EP-6-E Modified Polyamine-Silicone, EP-6-E/GP988

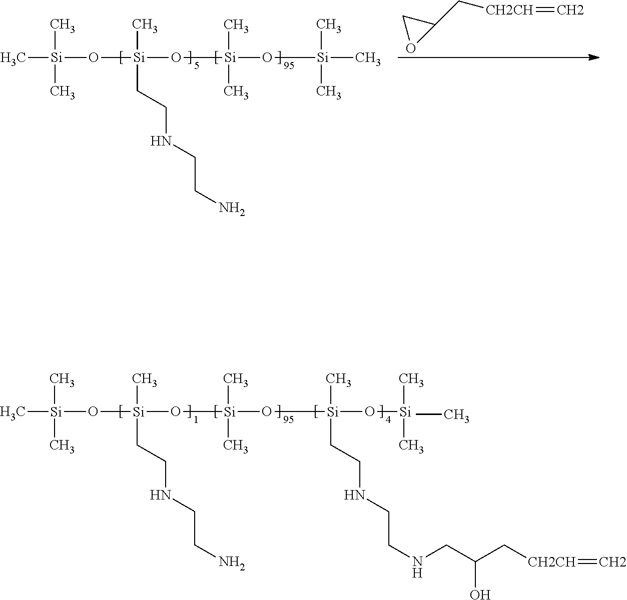

PEx3 was prepared in the same manner as PEx1 except that 16.06 g GP988 (10.05 meq) and 1.31 g EP-6 (8.04 meq), corresponding to an equivalent ratio of —NH₂ to epoxide of about 1 to 0.8, was used.

### Preparative Example 4 (PEx4)

### EP-10-E Modified Polyamine-Silicone, EP-10-E/GP988

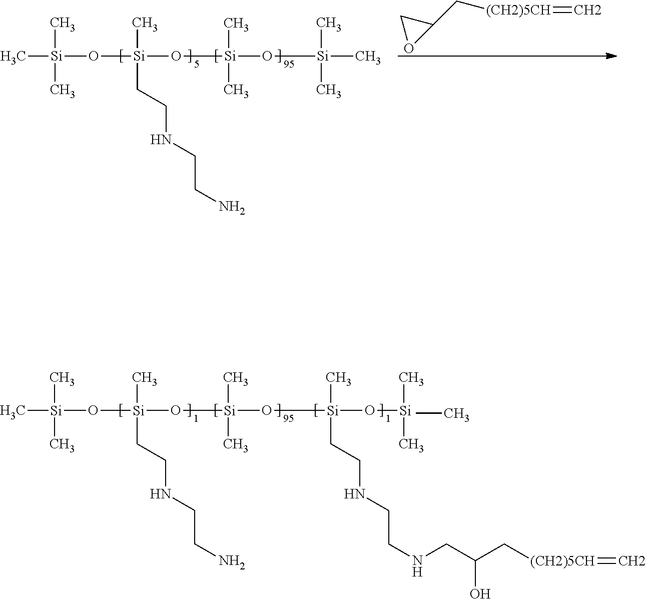

PEx4 was prepared in the same manner as PEx1 except that 16.27 g GP988 (10.18 meq) and 1.23 g EP-10-E (7.97 meq), corresponding to an equivalent ratio of —NH2 to epoxide of about 1 to 0.8, was used.

### General Method for Preparing QDEF Film Samples

All coating compositions were prepared in a nitrogen box. The quantum dot composites were prepared by pre-mixing about epoxy-ene modified polyamine silicone (prepared as described above in PEx1-PEx4 with G-QD and R-QD by rotation for 15 minutes, except Ex7 in which the epoxy-ene modified polyamine silicone was added after adding polythiol and polyene. The quantum dot coating compositions were prepared by adding TAIC, TEMPIC and TPO-L into the quantum dot composites. The resulting mixture was fully mixed with a high shear impeller blade (a Cowles blade mixer) at 1400 rpm for 4 minutes in the nitrogen box. The details of each formulation are described below.

When the coating compositions have additional antioxidant (AO, 2wt % of TAIC), it was generally pre-mixed with polyene, TAIC, before the procedure described above.

QDEF film samples were prepared by knife-coating the corresponding composition at a thickness of ˜100 micrometers between two barrier films. Then the film samples were first partially cured by exposing them to 385 nm LED UV light (Clearstone Tech CF200 100-240V 6.0-3.5A 50-60Hz) at 50% power for 10 seconds in N₂ box, then fully cured by Fusion-D UV light with 70% intensity at 60 fpm (18.29 meters per minute) under N₂.

Control samples were prepared in essentially the same manner except without the addition of epoxy-ene modified polyamine-silicone.

### Example 1 (Ex1), Example 2 (Ex2), and Comparative Example A (CExA)

Ex1, Ex2 and CExA samples were prepared as described above in General Method for Preparing QDEF Film Samples with details in Table 2. Ex1 was prepared using epoxy-ene modified polyamine silicone prepared as described in PEx1, and Ex2 was prepared using epoxy-ene modified polyamine silicone prepared as described in PEx2.

Quantum yield (EQE) of the resulting samples were tested as described above on samples as-prepared and after thermally aging the samples at 85° C. for 7 days. The edge ingress (EI) was also measured for the samples after aging. The data is summarized in Table 3, below.

The corresponding SHILT tests were conducted and the results are shown in FIG. 1 and FIG. 2.

The lifetime (LT), LT Improvement, and % LT Improvement were determined and summarized in Table 4, below.

TABLE 2

| | | | Modified Silicone | | | |
|---|---|---|---|---|---|---|
| Example | R-QD | G-QD | (amount in grams) | TEMPIC | TAIC | TPO-L |
| CExA | 0.4 g | 1.4 g | None | 26.65 | 14.03 g | 0.21 g |
| Ex1 | 0.4 g | 1.4 g | PEx1 (1.80) | 26.65 | 14.03 g | 0.21 g |
| Ex2 | 0.4 g | 1.4 g | PEx2 (1.80) | 26.65 | 14.03 g | 0.21 g |

TABLE 3

| | Modified | Initial | | Aged @ 85° C./7days | | |
|---|---|---|---|---|---|---|
| Example | Silicone | EQE | Abs | EI | EQE | Abs |
| CExA | None | −100% | 41.6% | 0.10 | 98.8% | 45.6% |
| Ex1 | PEx1 | −100% | 39.9% | 0.20 | 94.5% | 40.2% |
| Ex2 | PEx2 | 92.6% | 33.3% | 0.10 | 85.6% | 35.7% |

TABLE 4

| | Modified | LT | % LT | LT |
|---|---|---|---|---|
| Example | Silicone | (hours) | Improvement | Improvement |
| CExA | None | 4.41 | Control | Control |
| Ex1 | PEx1 | 7.67 | 73.9 | 1.74 |
| Ex2 | PEx2 | 6.20 | 55.0 | 1.55 |

### Examples 3-10 (Ex3-Ex10) and Comparative Example A to C (CExA-CExC)

Ex3-Ex10 were prepared in the same manner as Ex1 above except that the type and amount of the epoxy-ene modified polyamine-silicone used in the pre-mixture was varied, and additional antioxidant in Ex8-Ex10 and CExB-CExC.

Ex7 was prepared in the same manner as Ex6 except that epoxy-ene modified polyamine-silicone ligand (prepared as described in PEx3) was not added in to the pre-mixture. Instead, epoxy-ene modified polyamine-silicone ligand was added to the mixture along with TEMPIC, TAIC, and TPO-L.

The coating compositions used for preparing Ex3-Ex10 and CExA-CExC are summarized in Table 5, below.

TABLE 5

| | | | Modified | | | |
|---|---|---|---|---|---|---|
| | | | Silicone | | | |
| | R- | G- | (amount in | | | TPO- |
| Example | QD | QD | grams) | TEMPIC | TAIC/AO | L |
| CExA | 0.4 g | 1.4 g | None | 26.65 | 14.03 g/None | 0.21 g |
| Ex3 | 0.4 g | 1.4 g | PEx3 (1.80) | 26.65 | 14.03 g/None | 0.21 g |
| Ex4 | 0.4 g | 1.4 g | PEx3 (2.70) | 26.65 | 14.03 g/None | 0.21 g |
| Ex5 | 0.4 g | 1.4 g | PEx4 (1.80) | 26.65 | 14.03 g/None | 0.21 g |
| Ex6 | 0.4 g | 1.4 g | PEx1 (1.80) | 26.65 | 14.03 g/None | 0.21 g |
| Ex7 | 0.4 g | 1.4 g | PEx3 (1.80) | 26.65 | 14.03 g/None | 0.21 g |
| CExB | 0.4 g | 1.4 g | None | 26.65 | 14.03 g/AO-1 | 0.21 g |
| Ex8 | 0.4 g | 1.4 g | PEx3 (1.80) | 26.65 | 14.03 g/AO-1 | 0.21 g |
| CExC | 0.4 g | 1.4 g | None | 26.65 | 14.03 g/AO-2 | 0.21 g |
| Ex9 | 0.4 g | 1.4 g | PEx4 (1.80) | 26.65 | 14.03 g/AO-2 | 0.21 g |
| Ex10 | 0.4 g | 1.4 g | PEx1 (1.80) | 26.65 | 14.03 g/AO-1 | 0.21 g |

Quantum yield (EQE) of the resulting samples were tested as described above on samples as-prepared and after aging the samples for 7, 14, and 24 days at 50° C. The data is summarized in Table 6, below.

TABLE 6*

| | | | 50° C.- | | | | | |
|---|---|---|---|---|---|---|---|---|
| | Initial | | 7 Days | | 50° C.- | | 50° C.- | |
| | EQE | Abs | EQE | Abs | 14 Days | | 24 Days | |
| Example | % | % | % | % | EQE | Abs % | EQE | Abs % |
| CExA | ~100 | 39.8 | ~100 | 39.6 | ~100 | 40.4% | ~100 | 40.7% |
| Ex3 | ~100 | 31.0 | ~100 | 30.4 | ~100 | 30.4% | ~100 | 31.1% |
| Ex4 | 98.7 | 30.7 | ~100 | 31.6 | ~100 | 31.7% | ~100 | 32.4% |
| Ex5 | ~100 | 36.5 | ~100 | 36.1 | ~100 | 36.2% | ~100 | 36.7% |
| Ex6 | ~100 | 41.4 | ~100 | 4.6 | ~100 | 41.7% | ~100 | 41.3% |
| Ex7 | 99.0 | 36.2 | ~100 | 34.1 | ~100 | 34.4% | ~100 | 34.9% |
| Ex8 | ~100 | 29.7 | NT | NT | NT | NT | NT | NT |
| Ex9 | ~100 | 29.4 | NT | NT | NT | NT | NT | NT |
| Ex10 | ~100 | 37.5 | NT | NT | NT | NT | NT | NT |

*NT, means not tested.

The SHILT test was conducted and the results are shown in FIG. 3 and FIG. 4

The lifetime (LT), LT Improvement and % LT Improvement were determined and summarized in Table 7, below.

TABLE 7

| | LT | % LT | LT |
|---|---|---|---|
| Example | (hours) | Improvement | Improvement |
| CExA | 5.40 | Control | Control |
| Ex3 | 9.83 | 82.0% | 1.82 |
| Ex4 | 12.00 | 122.2% | 2.22 |
| Ex5 | 8.58 | 58.9% | 1.59 |
| Ex6 | 9.00 | 66.7% | 1.67 |
| Ex7 | 8.67 | 60.6% | 1.61 |
| CExB | 11.05 | 104.6% | 2.04 |
| Ex8 | 30.58 | 466% | 5.66 |
| CExC | 11.62 | 115.18 | 2.15 |
| Ex9 | 48.17 | 792% | 8.92 |
| Ex10 | 42.5 | 687% | 7.87 |

The complete disclosures of the publications cited herein are incorporated by reference in their entirety as if each were individually incorporated. Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

1. A quantum dot article comprising:
a first barrier layer,
a second barrier layer, and
a quantum dot layer between the first barrier layer and the second barrier layer, the quantum dot layer comprises light-emitting nanoparticles dispersed in a cured matrix; wherein the quantum dot layer further comprises a hydroxyl-functional unsaturated polyamine silicone ligand that is the reaction product of a polyamine silicone ligand and an unsaturated monofunctional epoxy compound.

2. The quantum dot article of claim 1 wherein the unsaturated monofunctional epoxy compound has the formula 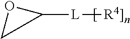
wherein L is a covalent bond or a polyvalent linking group, R⁴ is independently an unsaturated group, and n is at least 1.

3. The quantum dot article of claim 1 wherein the polyamine silicone ligand has the formula: 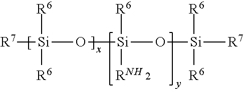
wherein
each R⁶ is independently alkyl, aryl, alkarylene, or aralkylene;
R^{NH2} is an amine-substituted (hetero)hydrocarbyl group;
x is at least 1, 2 or 3 and ranges up to 2000;
y is zero, 1 or greater than 1;
x+y is at least one;
R⁷ is alkyl, aryl or R^{NH2}
wherein amine-functional silicone has at least two R^{NH2} groups.

4. The quantum dot article of claim 3 wherein at least 50 mol-% of the —NH₂ groups have been converted to —NHCH₂CH(OH)L(R⁴)n; wherein L is a covalent bond or polyvalent linking group, R⁴ is independently an unsaturated group, and n is at least 1.

5. The quantum dot article of claim 1 wherein the matrix comprises a radiation cured polythiol and polyene.

6. The quantum dot article of claim 5 wherein the polyene has the formula 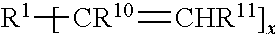
where
R¹ is a polyvalent (hetero)hydrocarbyl group,
each of R¹⁰ and R¹¹ are independently H or C₁-C₄ alkyl; and
x is ≥2.

7. The quantum dot article of claim 5 wherein the polythiol has the formula
R²(SH)_{y},
R² is a polyvalent (hetero)hydrocarbyl group.

8. The quantum dot article of claim 1 wherein the matrix further comprises photoinitiator.

9. The quantum dot article of claim 1 wherein when the article is illuminated by a single pass of 10,000 mW/cm² of 450 nm blue light at 50° C. the normalized converted radiance is greater than 85% of its initial value for at least 5 hours, or the article has a quantum yield (EQE) of at least 85% of its initial value after 1 week at 85° C.

10. A display device comprising the quantum dot article of claim 1.

11. A hydroxyl-functional polyamine silicone that is the reaction product of a polyamine silicone and an unsaturated monofunctional epoxy compound.

12. The hydroxyl-functional polyamine silicone of claim 11 wherein the unsaturated monofunctional epoxy compound has the formula 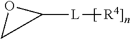
wherein L is a covalent bond or a polyvalent linking group, R⁴ is independently an unsaturated group, and n is at least 1.

13. The hydroxyl-functional polyamine silicone of claim 11 wherein the polyamine silicone ligand has the formula: 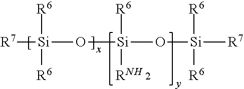
wherein
each R⁶ is independently alkyl, aryl, alkarylene, or aralkylene;
R^{NH2} is an amine-substituted (hetero)hydrocarbyl group;
x is at least 1, 2 or 3 and ranges up to 2000;
y is zero, 1 or greater than 1;
x+y is at least one;
R⁷ is alkyl, aryl or R^{NH2}
wherein the amine-functional silicone has at least two R^{NH2} groups.

14. The hydroxyl-functional polyamine silicone of claim 11 wherein at least 50 mol % of the —NH₂ groups have been converted to —NHCH₂CH(OH)L(R⁴)n; wherein L is a covalent bond or polyvalent linking group, R⁴ is independently an unsaturated group, and n is at least 1.

15. A hydroxyl-functional polyamine silicone ligand having the following general structure: 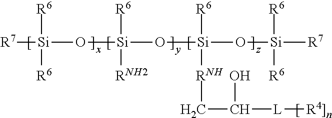
wherein
each R⁶ is independently alkyl, aryl, alkarylene, or aralkylene;
R^{NH2} is an amine-substituted (hetero)hydrocarbyl group;
x is at least 1, 2 or 3 and ranges up to 2000;
y is 0 to 10;
z is 0 to 10;
n is at least 1;
L is a covalent bond or polyvalent linking group;
R⁴ is independently an unsaturated group; and
R⁷ is alkyl, aryl, R^{NH2}, or —NHCH₂CH(OH)L(R⁴)n;
with the proviso that when z is 0 at least one R⁷ is —NHCH₂CH(OH)L(R⁴)n and when y is zero at least one R⁷ is R^{NH2}.

16. The hydroxyl-functional polyamine silicone ligand of claim 15 wherein the equivalent ratio of —R^{NH2} to —NHCH₂CH(OH)L(R⁴)n groups ranges from 1:0.5 to 1:0.95.

17. The hydroxyl-functional polyamine silicone ligand of claim 15 wherein the hydroxyl-functional polyamine silicone ligand has a weight average molecular weight ranging from 2,000 to 10,000 g/mole.

18. A quantum dot composition comprising:
light-emitting quantum dots; and
the hydroxy-functional polyamine silicone ligand of claim 15.

19. The quantum dot composition of claim 18 wherein the light-emitting quantum dots are core-shell nanoparticles.

20. A curable quantum dot composition comprising the quantum dot composition of claim 18 dispersed in a curable resin composition.

21. The curable quantum dot composition of claim 20 further comprising at least one polythiol and at least one polyene.

22. The curable quantum dot composition of claim 21 wherein the polyene has the formula 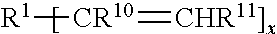
where
R¹ is a polyvalent (hetero)hydrocarbyl group,
each of R¹⁰ and R¹¹ are independently H or C₁-C₄ alkyl; and
x is ≥2.

23. The curable quantum dot composition of claim 21 wherein the polythiol has the formula
R²(SH)_{y},
R² is a polyvalent (hetero)hydrocarbyl group.

24. The quantum dot article of claim 1 wherein the quantum dot layer further comprises a hindered phenolic antioxidant.
